(19) United States
(12) Patent Application Publication
(10) Pub. No.: US 2011/0241896 A1
(43) Pub. Date: Oct. 6, 2011

(54) Aural warning processor

(76) Inventor: Holman Ricardo Camino, Bogota (CO)

(21) Appl. No.: 12/798,482

(22) Filed: Apr. 5, 2010

(51) Int. Cl. G08B 7/06; G08B 3/10

(52) U.S. Cl. 340/691.5; 340/692

(57) ABSTRACT

An aural warning processor includes a warning signal monitoring circuit and an audio output generation circuit under the operable control of a microcontroller. A system interface provides off-system electrical connectivity for the processor. The warning signal monitoring circuit is monitors the states of various subsystems of a host system with which the aural warning processor is used, as actually measured by through failure detection circuits otherwise provided with the host system and configured to produce electrical signals indicative of the existence of abnormal conditions in or pertaining to monitored subsystems. The electrical signals output from the failure detection circuits are conveyed to the warning signal monitoring circuit through the system interface, the control circuit operates to determine whether any conveyed signal is indicative of an abnormal condition and, if so, further operates to control generation of an appropriate audio message.

### FIELD OF THE INVENTION

The present invention relates to safety. More particularly, the invention relates to an aural warning processor adapted for integration with and into complex transportation systems and industrial facilities in order to bring accelerated and/or highlighted attention to an otherwise determined anomalous condition.

### BACKGROUND OF THE INVENTION

Complex transportation systems and complex industrial facilities, such as nuclear and hydroelectric power plants, are generally characterized as comprising a multitude of critical subsystems, the failure of any one of which having the potential to end in catastrophe. For example, vehicles providing means of mass conveyance, carriage or other transport, including, for further example, aircraft, such as airplanes and helicopters; rail vehicles, such as trains, trolleys and subways; and ships and other complex water vessels, such as barges, large boats and submarines all share the characteristic of comprising powerful propulsion systems. Likewise, such conveyances, typical comprise complex control systems and often involve operation in dangerous locations. Still further, these types of systems generally operate for the conveyance of or in close proximity to large groups of humans.

Because of the inherent danger involved in their operation as well as the complexity concomitant their operation or control, such systems and facilities are typically provided with some type of visual warning device adapted to provide a central location for collection of information relating to the anomalous or potentially anomalous operation of critical subsystems. For example, a helicopter such as is generally representative of the foregoing class of systems and facilities, typically comprises an annunciator panel (also often referred to in aircraft installations as a master caution panel or the like), which is typically installed among other instruments in an area of the instrument panel of the helicopter. As is known in the art, this type of annunciator panel comprises a plurality of indicator lights, which are color-coded or otherwise distinguished according to the severity or potential severity of the condition for which a particular indicator light is intended to warn. In order for the annunciator panel to be effective, however, the helicopter is also provided with a plurality of host system failure detection circuits such as, for example, temperature transducers, pressure transducers, voltage meters, ammeters and the like, which host system failure detection circuits may be and are often provided within or adjacent to various monitored subsystems including, for example, power plant subsystems (for which the host system failure detection circuits are adapted to monitor such critical operating parameters as engine fuel supply, engine oil temperature and/or engine oil pressure), drive train subsystems (for which the host system failure detection circuits are adapted to monitor such critical operating parameters as engine transmission oil temperature, engine transmission oil pressure, combining transmission oil temperature and combining transmission oil pressure) and other critical subsystems such as, for example, electric power generators (for which the host system failure detection circuits are adapted to monitor such critical operating parameters as voltage and/or current output).

Unfortunately, while most often reliable in practice, such visual indicators can themselves fail and, in any case, become ineffective in circumstances of task overload for crewmembers such as may result when the attention of crewmembers has been diverted from an otherwise closely monitored visual warning device for the handling of a low priority matter causing failure of the crewmembers to timely observe and react to a subsequently occurring high priority matter. Still further, environmental issues can arise such that the effectiveness of such visual indicators is diminished. For example, it is commonplace for a helicopter, or other similar host system, to be provided with a very large, generally transparent windscreen, side windows and even overhead window panels as are necessary to maximize exterior visibility for the crewmembers. Unfortunately, however, even with the provision of an instrument panel shroud, the provided windows results in much light entering the cockpit, which in some cases may make it very difficult for the crewmembers to notice an active indicator light on the annunciator panel.

With the foregoing discussion in mind, it is therefore an object of the present invention to improve over the prior art by providing an aural warning processor, which processor is specifically adapted to be integrated into or otherwise interfaced with a host system such that various typically critical subsystems of the host system may be monitored by the aural warning processor for the existence in one or more of the monitored subsystems of an anomalous condition, the processor being further adapted to generate, in response to the existence in a monitored subsystem of an anomalous condition, an aural warning message, thereby providing a backup warning indicator, redundant or supplemental to the disparate existing visual indicator and bringing accelerated and/or highlighted attention to an otherwise indicated warning.

Additionally, it is an object of the present invention to provide such an aural warning processor including facilities for integration with a preexisting host system and for shared utilization of various preexisting subsystems of the host system with which the aural warning processor is deployed for use, including such provisions as host system power sources, a host system circuit ground connection, warning subsystem user control inputs such as, for example, a reset switch and a test switch and/or an intercommunication subsystem, therefore being readily adaptable to variation for specific deployments.

Finally, many other features, objects and advantages of the present invention will be apparent to those of ordinary skill in the relevant arts, especially in light of the foregoing discussions and the following drawings, exemplary detailed description and appended claims.

### SUMMARY OF THE INVENTION

In accordance with the foregoing objects, the present invention—an aural warning processor—generally comprises a warning signal monitoring circuit and an audio output generation circuit, each circuit preferably being in electrical communication with and under the operable control of a control circuit. In the most preferred embodiment of the present invention, the aural warning processor further comprises a system interface adapted for and providing off-system electrical connectivity to and/or from the aural warning processor, preferably including electrical power and ground input connections, abnormal condition signal input connections, test and reset command signal input connections and at least one audio signal output connection.

The warning signal monitoring circuit is adapted and utilized for monitoring the states of various typically critical subsystems of a host system with which the aural warning processor is to be used, the state of such subsystems being actually measured by and/or through failure detection circuits otherwise provided in connection with the host system and adapted to produce electrical signals indicative of the existence of abnormal conditions in or pertaining to monitored subsystems. The electrical signals output from the host system failure detection circuits are conveyed to the warning signal monitoring circuit through the system interface, whereafter the control circuit operates to determine whether any such conveyed signal is indicative of an abnormal condition and, if so, further operates to control the generation through the audio output generation circuit of one or more appropriate audio messages, the audio warning messages being tailored to warn of the existence of the detected abnormality.

The most preferred embodiment of the aural warning processor contemplates implementation as a fully integrated unit, preferably contained in a metallic or like case of standardized dimension such that the unit may be mounted within the space of standardized electronics racks such as are typically provided in a host system of the type for which the present invention is to be utilized. In this manner, the aural warning processor may be readily integrated into a host system with all post-mounting installation being accomplished solely via electrical connections made through the system interface. To this end, the system interface of the aural warning processor of the present invention may simply comprise one or more conventional electrical connectors.

In the most preferred embodiment of the present invention, the control circuit comprises implementation of a general purpose microcontroller such as will typically advantageously include such desirable features as integrated program and data memory space, power-on reset functionality, interrupt capability and a fully integrated on-chip watchdog timer, all of which may contribute in varying degree to the efficient implementation of the desired functionality for the aural warning processor of the present invention. In particular, utilization for the control circuit of a general purpose microcontroller allows for a software-based implementation of a warning message selection and playback process. As a result, a robustly tailored scheme may be readily implemented for categorizing the signals generated by or through the host system failure detection circuits according to the severity or potential severity of an anomalous condition as may be detected thereby as affecting a monitored subsystem. For example, signals indicative of the imminent failure of a monitored critical subsystem may be categorized and labeled as being an “alarm” signal while signals indicative of and providing early warning to a merely potentially dangerous condition with respect to a monitored critical subsystem, such as requires less urgent attention than would an alarm-categorized anomaly, may be categorized and labeled as being a “caution” signal.

Where the signals generated by or through the host system failure detection circuits have been categorized according to the severity or potential severity of an anomalous condition as may be detected thereby, the implemented microcontroller may readily be and is preferably programmed to ascertain higher prioritized anomalies in advance of determining the existence of lower prioritized anomalies. Additionally, in such an implementation, the microcontroller is also preferably programmed to monitor (by and through control of the warning signal monitoring circuit) higher prioritized signals generated by or through the host system failure detection circuits during playback through the integrated message playback circuit of an aural warning message corresponding to a lower prioritized anomaly and, upon detection of any higher prioritized and/or otherwise superseding anomaly, the microcontroller is still further preferably programmed to terminate playback through the integrated message playback circuit of the aural warning message corresponding to the lower prioritized anomaly in favor of the immediate selection and playback of an aural warning message corresponding to the newly detected superseding anomaly.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a perspective view, the interior cockpit space of a modern helicopter such as is generally representative of the crew space of a typical host vehicle in and in connection with which it is to be expected that the present invention will be integrated for use;

FIG. 2 shows, in a plan view, details of a typical visual warning annunciator panel such as is generally representative of the type of visual warning system typically provided in and in connection with the type of host vehicle with which it is to be expected that the present invention will be utilized;

FIG. 3 shows, in a functional block diagram, the most preferred manner of integration of the aural warning processor of the present invention with a typical host vehicle;

FIGS. 4A and 4B, which collectively form FIG. 4, shows, in a schematic diagram, the preferred embodiment of the aural warning processor of the present invention;

FIGS. 5 through 10 collectively shows, in flowcharts, an exemplary program flow intended to emphasize various features and functions as may be implemented through the aural warning processor of FIG. 4 and to detail at least one preferred method for use of the aural warning processor of FIG. 4, wherein specifically for this exemplary program flow:

FIG. 5 shows the main program as executed upon power on or detection of a reset event;

FIG. 6 shows a test routine as may be called for execution from the main program of FIG. 5 or from elsewhere in the overall program flow;

FIG. 7 shows a monitor routine as may be called for execution from the main program of FIG. 5 or from elsewhere in the overall program flow and which, in the exemplary implementation as described, operates as a continuously repeating loop during power on of the aural warning until and unless terminated for a reset event;

FIG. 8 shows a get warning status function as may be called from within various locations of program flow for obtaining necessary status information with respect to the present operation of the systems or subsystems of the host vehicle with which the aural warning processor of the present invention is utilized;

FIG. 9 shows the normal order of execution of the subroutines forming the sound alarm routine as may be called from within various points of execution of the monitor and related routines;

FIG. 9A shows various details of the announce alarm condition subroutine of the sound alarm routine of FIG. 9;

FIG. 9B shows various details of the playback all alarm messages subroutine of the sound alarm routine of FIG. 9;

FIG. 10 shows the normal order of execution of the subroutines forming the sound caution routine as may be called from within various points of execution of the monitor and related routines;

FIG. 10A shows various details of the announce caution condition subroutine of the sound caution routine of FIG. 10;

FIG. 10B shows various details of the playback caution message subroutine of the sound caution routine of FIG. 10; and

FIG. 10C shows various details of the additional caution determination subroutine of the sound caution routine of FIG. 10.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

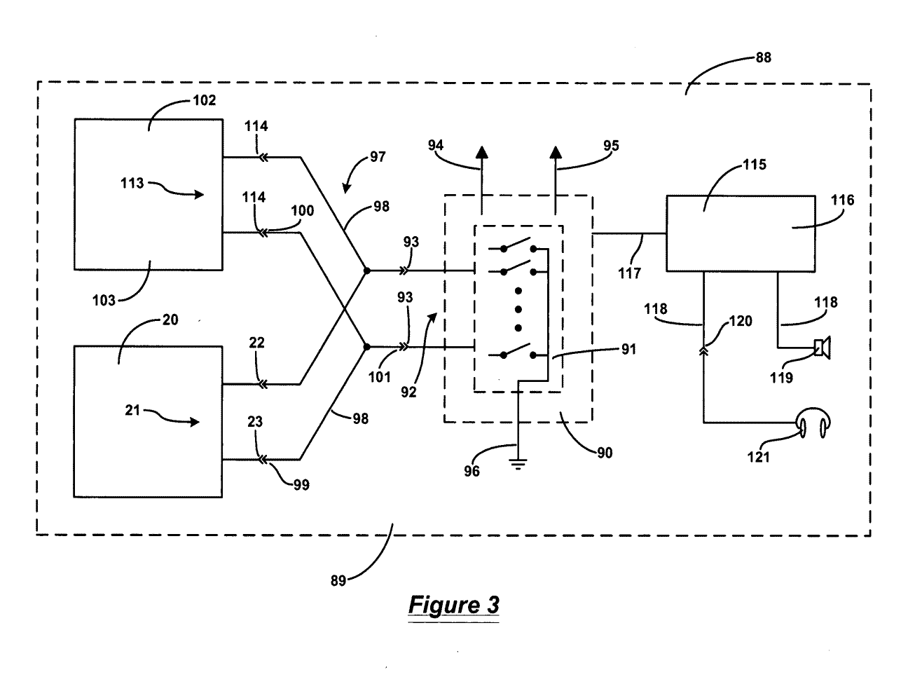

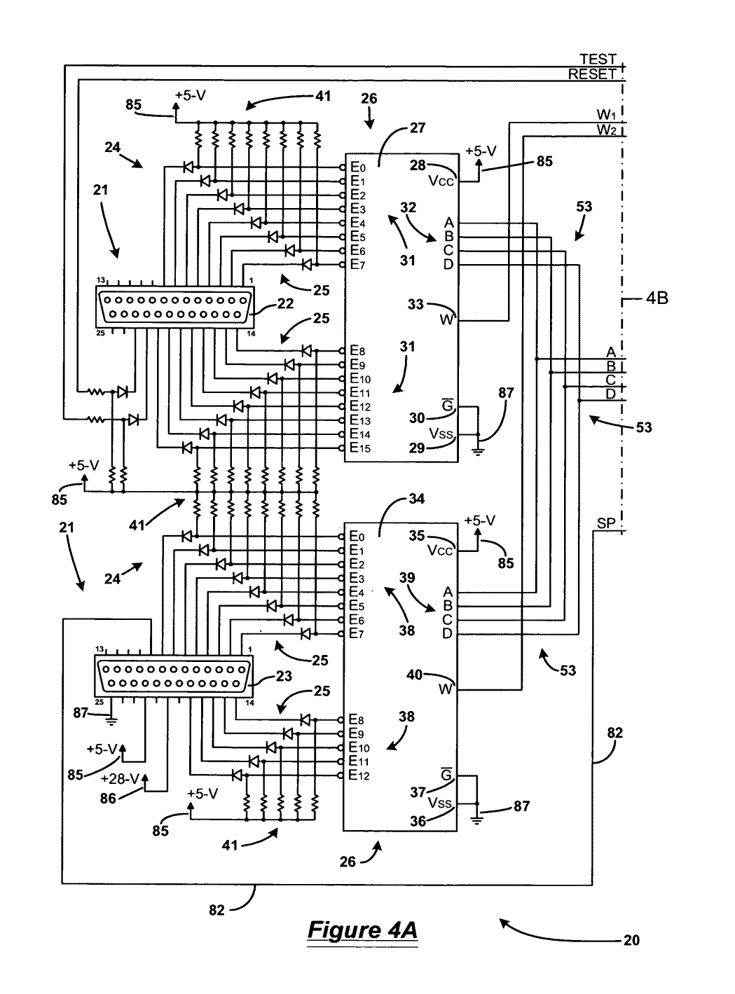

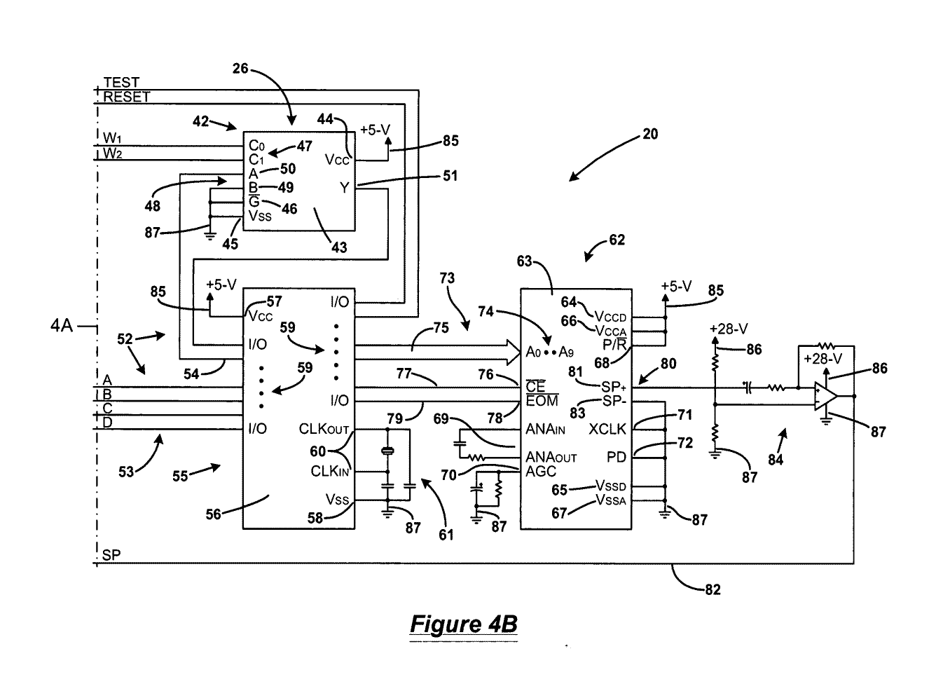

Referring now to the figures and to FIGS. 3 and 4 in particular, the aural warning processor 20 of the present invention is shown to broadly comprise a warning signal monitoring circuit 26 and an audio output generation circuit 62, each circuit 26, 62 preferably being in electrical communication with and under the operable control of a control circuit 55. In the most preferred embodiment of the present invention, the aural warning processor 20 further comprises a system interface 21 adapted for and providing off-system electrical connectivity to and/or from the aural warning processor 20, preferably including, for example and as will be better understood further herein, electrical power and ground input connections, abnormal condition signal input connections, test and reset command signal input connections and at least one audio signal output connection. As will be better understood further herein, the warning signal monitoring circuit 26 is adapted and utilized for monitoring the state of various typically critical subsystems 90 of a host system 88 with which the aural warning processor 20 is to be used, the state of such subsystems 90 being actually measured by and/or through failure detection circuits 91 otherwise provided in connection with the host system 88 and adapted to produce electrical signals indicative of the existence of abnormal conditions in or pertaining to monitored subsystems 90. As also will be better understood further herein, the electrical signals output from the host system failure detection circuits 91 are conveyed to the warning signal monitoring circuit 26 through the system interface 21, whereafter the control circuit 55 operates to determine whether any such conveyed signal is indicative of an abnormal condition and, if so, further operates to control the generation through the audio output generation circuit 62 of one or more appropriate audio messages warning of the existence of the so detected abnormality.

Although the aural warning processor 20 as otherwise described herein may be implemented in a distributed configuration, the most preferred embodiment of the present invention contemplates implementation as a fully integrated unit, preferably contained in a metallic or like case of standardized dimension such that the unit may be mounted within the space of standardized electronics racks such as are typically provided in a host system 88 of the type for which the present invention is to be utilized. In this manner, as particularly shown in FIG. 3, the aural warning processor 20 may be readily integrated into a host system 88 with all post-mounting installation being accomplished solely via electrical connections made through the system interface 21. To this end, as shown in FIG. 4, the system interface 21 of the aural warning processor 20 of the present invention may simply comprise one or more conventional electrical connectors 22, 23 such as, for example, DB-25 or like type jacks or plugs as ubiquitously known in the relevant arts or any other substantially equivalent electrical connector.

While those of ordinary skill in the art will, especially in light of this exemplary description, recognize that the control circuit 55 for the aural warning processor 20 of the present invention may be implemented in a wide range of technologies and with varying degrees of complexity, such as, for example, as a simple state machine implemented in basic logic devices, the most preferred embodiment of the control circuit 55 comprises implementation of a general purpose microcontroller 56, as shown in FIG. 4. While any of a very wide variety of microcontrollers may be utilized with varying advantage, the preferred embodiment of the present invention contemplates selection of a microcontroller such as, for example, one of the high-speed, low-power series PIC-16xxx 8-bit CMOS microcontrollers commercially available from Microchip Technology, Inc. under its trademark “MICROCHIP.” As will be appreciated by those of ordinary skill in the art, these type microcontrollers advantageously include such desirable features as integrated program and data memory space, power-on reset functionality, interrupt capability and a fully integrated on-chip watchdog timer, all of which may contribute in varying degree to the efficient implementation of the desired functionality for the aural warning processor 20 of the present invention, as such desired functionality is described in greater detail further herein.

Regardless of whether any or all of the foregoing advantageous features are provided, however, it is noted that utilization of a general purpose microcontroller 56 for implementation of the control circuit 55 facilitates implementation of the audio output generation circuit 62 with an integrated message playback circuit 63 such as, for example, the ISD series fully integrated, single-chip digital message recording and playback devices as commercially marketed by Information Storage Devices, Inc. of San Jose, Calif. under its trademarks “ISD” and “CHIPCORDER” and/or the trademark “WINBOND” of its parent company Winbond Electronics Corp. of Taiwan or any substantially equivalent message recording and playback device. In particular, utilization for the control circuit 55 of a general purpose microcontroller 56 allows for a software-based implementation of the warning message selection and playback process, at least one preferred example of which process is described in greater detail further herein. As a result, and as will also be better understood further herein, a robustly tailored scheme may be readily implemented for categorizing the signals generated by or through the host system failure detection circuits 91 according to the severity or potential severity of an anomalous condition as may be detected thereby as affecting a monitored subsystem 90. For example, signals indicative of the imminent failure of a monitored critical subsystem 90 may be categorized and labeled as being an “alarm” signal while signals indicative of and providing early warning to a merely potentially dangerous condition with respect to a monitored critical subsystem 90, such as requires less urgent attention than would an alarm-categorized anomaly, may be categorized and labeled as being a “caution” signal.

While the realm of possible categorizations is virtually limitless, it should be appreciated that at least some minimal level of categorization, as has been described, is highly desirable inasmuch as such categorization, especially when implemented as part of or in connection with the programming of the microcontroller 56, enables the programming or further programming of the microcontroller 56 for the prioritized delivery of aural warnings. In particular, as also will be better understood further herein, the microcontroller 56, which is programmed to control the selection and playback through the integrated message playback circuit 63 of aural warning messages, is preferably further programmed to apply any implemented priority scheme to such selection and playback. For example, as will be detailed further herein, an implemented microcontroller 56 may readily be and is preferably programmed to ascertain alarm-categorized anomalies in advance of determining the existence of caution-categorized anomalies. Likewise, the microcontroller 56 is also preferably programmed to monitor (by and through control of the warning signal monitoring circuit 26) alarm-categorized signals generated by or through the host system failure detection circuits 91 during playback through the integrated message playback circuit 63 of an aural warning message corresponding to a caution-categorized anomaly and, upon detection of any alarm-categorized, higher priority and/or otherwise superseding anomaly, the microcontroller 56 is still further preferably programmed to terminate playback through the integrated message playback circuit 63 of the aural warning message corresponding to the caution-categorized anomaly in favor of the immediate selection and playback of an aural warning message corresponding to the newly detected superseding anomaly.

In any case, as particularly shown in FIG. 4B, the integrated message playback circuit 63 as implemented in the aural warning processor 20 of the present invention is preferably configured for use exclusively as a playback device optimized for voice band audio output frequencies. In this manner, any risk for inadvertent corruption of a stored aural warning message is minimized and the quality of the produced audio output signal is maximized. Although, as will be appreciated by those of ordinary skill in the art, the precise configuration will depend upon the features provided by the manufacturer of a particular integrated message playback circuit 63, the following setup, which is provided as an exemplary only guide to the most preferred implementation of the present invention, is deemed by Applicant as being appropriate in the case of implementation with an ISD series type device: any provided playback/record mode select input 68 should be fixed for the selection of the playback mode, which, as shown in FIG. 4B, is accomplished in the depicted ISD series type device by tying the input 68 to the +5-Vdc power bus 85; any provided analog input and/or output 69 should be configured, if at all, as specified by the device manufacturer for use of the device as otherwise set forth herein, which, as shown in FIG. 4B, may involve the provision of external circuitry; any provided automatic gain control input 70 should be configured according to the device manufacturer's specification for minimal distortion of voice band audio frequencies; and any provided power down input 72 should be configured to prevent the integrated message playback circuit 63 from entering a “standby” or like mode, thereby ensuring that the device does not become inadvertently unavailable for the immediate playback of an aural warning message. Additionally, because the accuracy of internal clock of the exemplary implemented ISD series type integrated message playback circuit 63 is deemed sufficient for utilization as otherwise described herein and also because master timing for the aural warning processor 20 is implemented in connection with the microcontroller 56 utilizing, for example, a crystal oscillator 61 tied to the external clock pins 60 of the microcontroller 56, the provided external clock input 71 is, as also shown in FIG. 4B, tied to the ground bus 87 as specified by the device manufacturer for utilization of the internally provided clock in favor of provision of a separate, external clock circuit. Those of ordinary skill in the art will recognize, however, that the implementation of any particular device will require consideration of various device-specific requirements, the most important consideration being that each requirement be addressed with a view toward providing an audio output generation circuit 62 that is stable and reliable in use and otherwise compatible with the other components of the aural warning processor 20 as described herein.

In any case, as particularly shown in FIG. 4B, various control inputs and output 73 for the integrated message playback circuit 63 are connected to the microcontroller 56, through various input/output (“I/O”) ports 59 of the microcontroller 56, for control of the selection and playback of a desired aural warning message according to the preferred method for use of the present invention, as will be described in greater detail further herein. In particular, a plurality of the I/O ports 59 of the microcontroller 56 are connected through a message address bus 75 to the message address select pins 74 of the integrated message playback circuit 63, thereby enabling use of the control circuit 55 for the selection by address location of a particular desired aural warning message as stored in the provided internal memory of the integrated message playback circuit 63. In at least one preferred embodiment of the present invention, at least one other I/O port 59 of the microcontroller 56 is connected through at least one enable control line 77 to at least one chip enable input 76 provided on the integrated message playback circuit 63. As will be appreciated by those of ordinary skill in the art, the described scheme allows a particular aural warning message to be generated through the audio output generation circuit 62 by essentially selecting the appropriate address followed by enabling the integrated message playback circuit 63, which, as previously described, is preferably fixedly configured for the playback mode. Additionally, in order to relieve the control circuit 55 of the requirement for independently determining when a selected aural warning message has completed, a further I/O port 59 of the microcontroller 56 is preferably connected through an end-of-message signal line 79 to an end-of-message flag output 78 as advantageously provided on the implemented ISD series type integrated message playback circuit 63 to positively indicate completion of playback of a particular aural message by generating an end-of-message flag signal. As will also be appreciated by those of ordinary skill in the art, such a provision enables the microcontroller 56 to be programmed to accept the end-of-message flag in the manner of a program interrupt, enabling the software associated with the microcontroller 56 to move immediately to further program steps following the completion of playback of an aural warning message.

Finally, as also particularly shown in FIG. 4B, the ISD series type integrated message playback circuit 63, as implemented in the preferred embodiment of the present invention, further comprises a differential audio output 80. As shown, however, the provided audio output 80 is operated in the exemplary embodiment in single-ended mode by tying the negative speaker output 83 to the ground bus 87 and taking the audio output signal from the positive speaker output 81, as specified by the device manufacturer. As will be better understood further herein, this particular configuration choice, i.e., differential versus single-ended output, is largely a matter of implementation that in general will depend upon the ultimate termination of the audio output line 82 as will be discussed in greater detail further herein. In any case, however, such variations in implementation are well within the capabilities of those of ordinary skill in the art.

As previously discussed, the aural warning processor 20 of the present invention comprises (as a major element thereof) a warning signal monitoring circuit 26, which warning signal monitoring circuit 26 is under the operable control of the control circuit 55 whether the control circuit be implemented with a microcontroller 56 or otherwise. Although overall complexity will vary according to the particular implementation of the control circuit 55, the warning signal monitoring circuit 26 may in any case generally be implemented as a one of many inputs data selector circuit, such circuits being well known to those of ordinary skill in the art. Additionally, as also will be appreciated by those of ordinary skill in the art, such a selector circuit may be implemented utilizing one or more devices and/or in one or more stages. For example, as shown in FIG. 4, at least one preferred embodiment of the warning signal monitoring circuit 26 comprises a first multiplexer 27 and a second multiplexer 34 arranged as first and second independent input channels forming a first stage of a one of many inputs data selector circuit, as particularly shown in FIG. 4A, and a third multiplexer 43 arranged as a channel selection circuit 42 for the one of many inputs data selector circuit, as particularly shown in FIG. 4B.

Although those of ordinary skill in the art will recognize that many alternative embodiments may be readily implemented, Applicant has found it suitable for implementation of the present invention to utilize any of the well known TTL or functionally equivalent 16 to 1 type multiplexers as are widely available for implementation of each the first multiplexer 27 and the second multiplexer 34. Likewise, Applicant has found it suitable for implementation of the present invention to utilize any of the well known TTL or functionally equivalent 4 to 1 type multiplexers as are widely available for implementation of the third multiplexer 43, forming the channel selection circuit 42.

In any case, as particularly shown in FIG. 4A, the data inputs 31 for the first multiplexer 27 are in the depicted exemplary arrangement in electrical communication with various pins (or holes) of the first connector 22 of the system interface 21 while the data inputs 38 for the second multiplexer 34 are in electrical communication with various pins (or holes) of the second connector 23 of the system interface. Additionally, as shown in FIG. 4, the data select inputs 32 for the first multiplexer 27 and the data select inputs 39 for the second multiplexer 34 are in electrical communication with the control circuit 55. In particular, as shown in FIG. 4B, the data select inputs 32, 39 connect through a common bus 53 to a plurality of the I/O ports 59 of the implemented microcontroller 56. As will be appreciated by those of ordinary skill in the art, this arrangement enables the software associated with the microcontroller 56 to simultaneously select, according to the signal established on the common bus 53, which data inputs 31, 38 are to be directed to the respective data outputs 33, 40 of the first and second multiplexers 27, 34, respectively.

As shown in FIG. 4, the data outputs 33, 40 from the first and second multiplexers 27, 34, respectively, are in the depicted exemplary arrangement in electrical communication with the data inputs 47 of the implemented third multiplexer 43. As shown in FIG. 4B, the data select inputs 48 of the third multiplexer 43 are configured to enable selection through the control circuit 55 of which of the two depicted data inputs 47 is to be directed to the data output 51 of the third multiplexer and thereby which single signal input through the system interface 21 is to be communicated to the control circuit 55 for further processing in accordance with the preferred method of use of the present invention. In particular, the select most significant bit input 49 of the third multiplexer 43 is tied to the ground bus 87 while the select least significant bit input 50 is in electrical communication through a channel selection line 54 with one of the I/O ports 59 of the microcontroller 56. As will be appreciated by those of ordinary skill in the art, the arrangement thus shown and described contemplates a 5-bit signal selection bus 52, wherein the most significant bit is utilized through the channel selection line 54 to select one of the first and second multiplexers 27, 34 while the four least significant bits are utilized through the common bus 53 to select which of the up to 16 signals input to the selected one of the first and second multiplexers 27, 34 is passed through the third multiplexer 43 for input through an I/O port 59 into the microcontroller 56.

As previously discussed, the control circuit 55 of the aural warning processor 20 of the present invention may be implemented in any of a number of technologies of widely varying complexity, ranging at least from the implementation of a state machine to implementation, as depicted in the exemplary FIG. 4, of a microcontroller 56. As also previously discussed, the selected implementation will in general also affect the ease with which other features and functions of the present invention are in practice realized. For example, it has been previously noted that implementation of the control circuit 55 with a microcontroller 56 enables execution of program flow in software, which, as will be well known to those of ordinary skill in the art, is generally more readily adaptable to variation for specific deployments. By way of at least one example, as has been previously discussed in at least general terms, such a software implementation of the desired prioritization scheme for detected anomalies enables easily realized changes to the number of possible categorizations; easily realized changes to the assignment of anomalies to particular categorizations; easily realized changes to what systems and corresponding potential anomalies are to be monitored; and easily realized changes to selection of an aural warning message for response to a detected anomaly.

Additionally, however, it is noted that implementation of the control circuit 55 with a microcontroller 56 also facilitates interaction between the various components of the aural warning processor 20, particularly including, but in no manner being limited to, handling matters of timing such as are well known to those of ordinary skill in the art as generally being critical to the reliable implementation of an electronic system. For example, as shown in FIG. 4, the strobe input 30 (or circuit enable) of the first multiplexer 27, the strobe input 37 of the second multiplexer 34 and the strobe input 46 of the third multiplexer 43 (each being depicted as being active low) are all tied to the ground bus 87, enabling the data outputs 33, 40, 51 of the respective multiplexers 27, 34, 43 to immediately reflect the selected data inputs 31, 38, 47. As will be appreciated by those of ordinary skill in the art, any issue of sample timing, as may be of greater concern in an implementation of a state machine for the control circuit 55, is readily dealt with in the software deployed in implementing the control circuit 55 with a microcontroller 56. In particular, those of ordinary skill in the art will be readily able to ensure, through the software accompanying the microcontroller 56, that the slew rates for each of the multiplexers 27, 34, 43 as well as any other timing issues are fully accounted for to ensure that a signal input to the microcontroller 56 from the data output 51 of the third multiplexer 43 is in fact representative of the signal input through the system interface 21 as previously selected through the signal selection bus 52 by the microcontroller 56, thereby ensuring that any generated aural warning message faithfully corresponds to the actual abnormal condition giving rise to the generation thereof.

As previously discussed, the aural warning processor 20 of the present invention is adapted to be integrated into or otherwise interfaced with a host system 88 such that various typically critical subsystems 90 of the host system 88 may be monitored by the aural warning processor 20 for the existence in one or more of the monitored subsystems 90 of an anomalous condition. Additionally, as also previously discussed, the aural warning processor 20 of the present invention is adapted to generate, in response to the existence in a monitored subsystem 90 of an anomalous condition, an aural warning message. Because the principle purposes of the aural warning processor 20 of the present invention are (1) to provide a backup warning indicator, redundant or supplemental to a disparate existing indicator and (2) to bring accelerated and/or highlighted attention to an otherwise indicated warning, the preferred embodiment of the aural warning processor 20 of the present invention also contemplates (1) provision as part of the aural warning processor 20 of facilities for integration of the aural warning processor 20 with a preexisting host system 88 and (2) shared utilization by the aural warning processor 20 of various preexisting subsystems of the host system 88 with which the aural warning processor 20 is deployed for use, including not only the previously discussed host system failure detection circuits 91, but also such provisions as host system power sources 94, 95, a host system circuit ground connection 96, warning subsystem user control inputs such as, for example, a reset switch 111 and a test switch 112 and/or an intercommunication subsystem 115.

With the foregoing objects and considerations in mind, it is noted that host systems 88 for which the aural warning processor 20 of the present invention is most particularly suited generally comprise complex transportation systems such as, for example, vehicles providing means of mass conveyance, carriage or other transport, including, for further example, aircraft, such as airplanes and helicopters; rail vehicles, such as trains, trolleys and subways; and ships and other complex water vessels, such as barges, large boats and submarines. Additionally, however, the present invention contemplates that the aural warning processor 20 may be adapted for use in or in connection with complex industrial facilities, including, for example, nuclear and hydroelectric power plants. While those of ordinary skill in the art will recognize that many of the teachings of the present invention may be broadly extended, it should also be understood that that the greatest advantages of the present invention are generally achieved by implementations achieving, individually or, most advantageously, in combination, those features addressed in the previous paragraph.

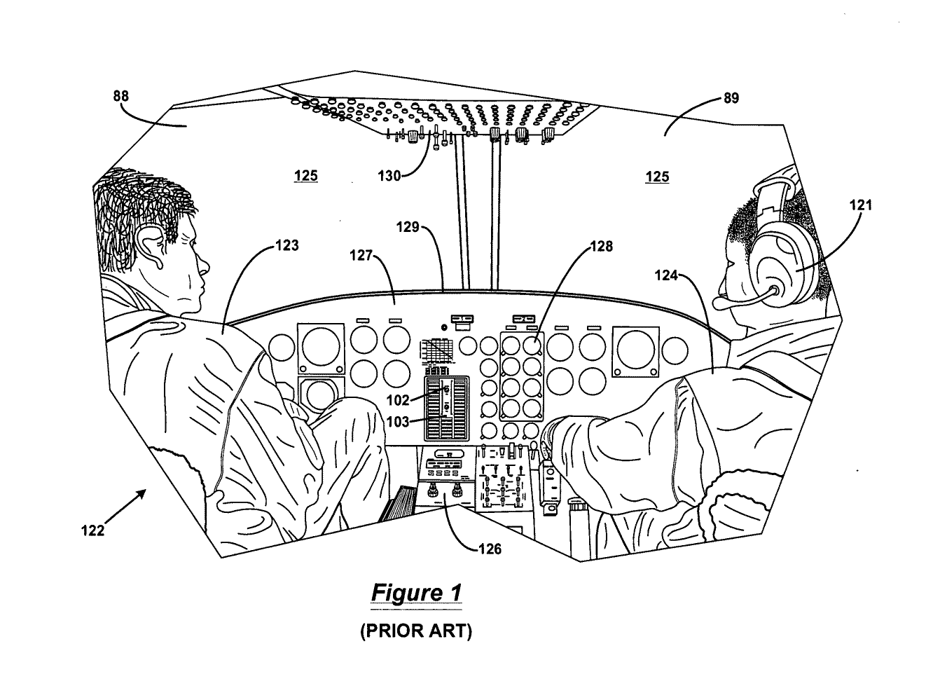

Referring then to FIGS. 1 through 4 in particular, it is shown that one such host system 88 as is particularly suited for application of the teachings of the present invention is the depicted helicopter 89. As will be appreciated by those of ordinary skill in the art, a helicopter 89 as contemplated in the present invention is generally always provided with a number of host system failure detection circuits 91 such as, for example, temperature transducers, pressure transducers, voltage meters, ammeters and the like, which host system failure detection circuits 91 may be and are often provided within or adjacent to various monitored subsystems 90 including, for example, power plant subsystems (for which the host system failure detection circuits 91 are adapted to monitor such critical operating parameters as engine fuel supply, engine oil temperature and/or engine oil pressure), drive train subsystems (for which the host system failure detection circuits 91 are adapted to monitor such critical operating parameters as engine transmission oil temperature, engine transmission oil pressure, combining transmission oil temperature and combining transmission oil pressure) and other critical subsystems such as, for example, electric power generators (for which the host system failure detection circuits 91 are adapted to monitor such critical operating parameters as voltage and/or current output).

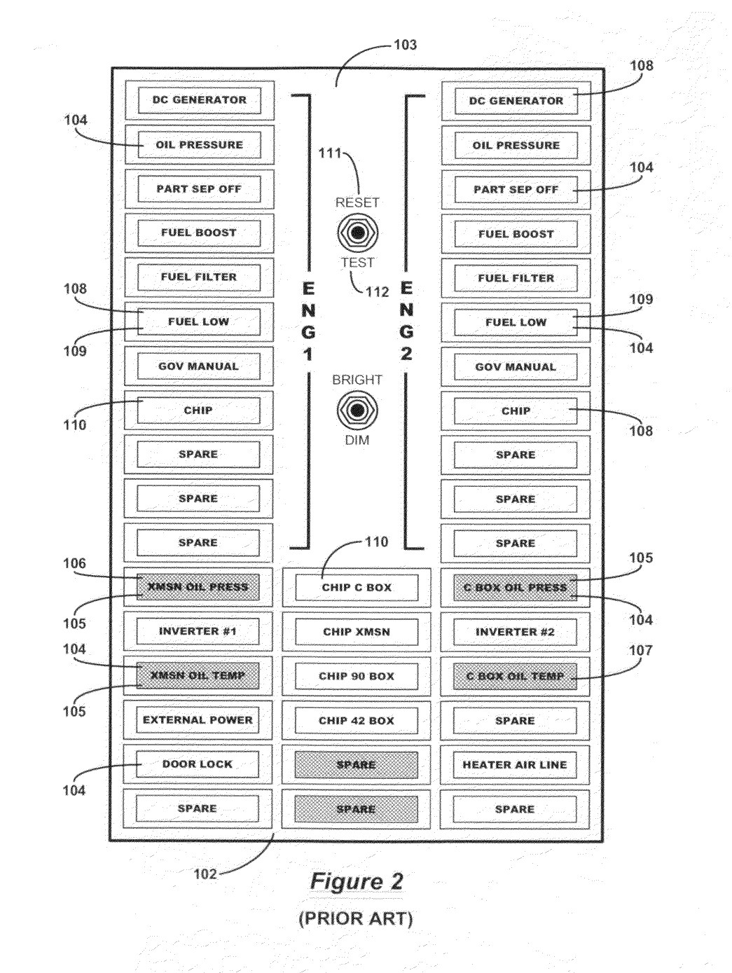

Additionally, as particularly shown in FIGS. 1 through 3, the helicopter 89 as generally representative of host systems 88 appropriate for deployment of the present invention is depicted as comprising a visual warning device 102, which is also generally characteristic of the types of host systems 88 for use with which is intended the aural warning processor 20. In particular, the helicopter 89 is shown to comprise a conventional annunciator panel 103 (also often referred to in aircraft installations as a master caution panel or the like), which is typically installed among other instruments 128 in an area of the instrument panel 127 of the helicopter 89, as shown in FIG. 1. As particularly shown in FIG. 2, the depicted exemplary annunciator panel 103 comprises a plurality of indicator lights 104, which as is also typical of visual warning devices 102 for all types of host systems 88, are color-coded or otherwise distinguished according to the severity or potential severity of the condition for which a particular indicator light 104 is intended to warn. For example, the annunciator panel 103 of FIG. 2 is shown to comprise a plurality of indicator lights 104 comprising red, or otherwise distinguished, colored lenses (represented in the drawing with hatching) for designation as imperative indicators 105 while other of the indicator lights 104 are shown to comprise, for example, white colored lenses (represented in the drawing by the absence of hatching) for designation as precautionary indicators 108.

As is typical in implementations of a visual warning device 103 for use in an aircraft, the indicator lights 104 particularly shown in FIG. 2 as being imperative indicators 105 generally indicate the imminent failure of a critical system 90 of the helicopter 89 or a like high-priority condition such as generally demands the immediate attention of the crewmembers 123, 124 of the helicopter 89. In particular, as shown in the exemplary depiction, the so designated imperative indicators 105 include such indicator lights 104 as the engine transmission oil pressure warning light 106 and the combining transmission oil temperature warning light 107, each of which are intended to warn the crewmembers 123, 124 of a situation that if not immediately addressed could result in catastrophic failure of the helicopter 89. On the other hand, as is also typical in implementations of a visual warning device 103 for use in aircraft, the indicator lights 104 particularly shown in FIG. 2 as being precautionary indicators 108, which are often implemented as yellow or white colored lights, generally merely provide early warning to the crewmembers 123, 124 of the helicopter 89 of a potentially dangerous condition such as does not generally constitute an immediate emergency. In particular, as shown in the exemplary depiction, the so designated precautionary indicators 108 include such indicator lights 104 as the low fuel indicator lights 109 and the chip detection indicator lights 110 (illuminated when metal chips, such as may result from excessive parts wear, accumulate in various oil flows or reservoirs), each of which are intended to draw attention of the crewmembers 123, 124 to a situation that if left unchecked could develop into an emergency matter.

As will be appreciated by those of ordinary skill in the art, especially in light of the immediately foregoing and earlier exemplary discussions, the described categorization of indicator lights 104 as typically implemented in a helicopter 89 of the type for which the aural warning processor 20 of the present invention is particularly adapted for use is well suited for implementation of the previously described desirable scheme for categorizing in the aural warning processor 20 of signals generated by or through the host system failure detection circuits 91 according to the severity or potential severity of an anomalous condition such as may be detected by or through the host system failure detection circuits 91 as affecting a monitored subsystem 90. To be sure, the scheme implemented with respect to the annunciator panel 103 of the helicopter 89 may be, if desired, adopted for use in the aural warning processor 20 without change. In such a case, and with specific reference to Applicant's earlier exemplary discussion, a signal generated by or through the host system failure detection circuits 91 of the helicopter 89 of a nature as to ultimately cause activation of one of the indicator lights 104 of the annunciator panel 103 as has been designated an imperative indicator 105 is for purposes of implementing the aural warning processor 20 of the present invention categorized and labeled as being an “alarm” signal. Likewise, a signal generated by or through the host system failure detection circuits 91 of the helicopter 89 of a nature as to ultimately cause activation of one of the indicator lights 104 of the annunciator panel 103 as has been designated a precautionary indicator 108 is for purposes of implementing the aural warning processor 20 of the present invention categorized and labeled as being an “caution” signal.

It is emphasized, however, that one advantage (among many others) of the aural warning processor 20 of the present invention is that any preexisting scheme, such as described in the preceding discussion, need not be followed precisely or, for that matter, followed at all, the aural warning processor 20 being particularly adapted for a far more robust implementation of any categorization and/or prioritization scheme applied to the warning signals as otherwise conveyed from the host system failure detection circuits 91 through the system interface 21 of the aural warning processor 20 to the controller 55 implemented therein and adapted for application of the scheme. For example, it should be recognized that the assignments of such conveyed warning signals to particular categories may be more inclusive or less inclusive as may be desired in a particular implementation. Likewise, more than two categories may readily be implemented and, in fact, each conveyed warning signal may be individually treated, essentially resulting in a complete prioritization scheme.

Further, an implemented scheme may include conditional prioritization. To this end, it may be that the controller 55 of the aural warning processor 20 is programmed or otherwise adapted to ignore conveyed warning signals with categorizations prioritized lesser than another in the event that a warning signal having the higher prioritized categorization has been conveyed, as, in fact, will be described in greater detail further herein in discussion of one preferred method of use of the present invention. In an adaptation of this concept, it may be that the controller 55 of the aural warning processor 20 is programmed or otherwise adapted to ignore as a matter of course conveyed warning signals of specified prioritization. For example, the aural warning processor 20 of the present invention may be adapted to generate an aural warning message in response to the determination of the existence of any alarm-categorized anomaly, but, on the other hand, adapted to never generate an aural warning message in response to the determination of the existence of a caution-categorized anomaly.

Further still, the aural warning processor 20 of the present invention may be adapted to generate one or more aural messages indicative of a determination of the existence of a particularly categorized anomaly, but not specific to the particular anomaly. For example, a tone may be generated to indicate that some unspecified alarm-categorized anomaly has been detected whereafter may follow a specific aural message that identifies the particular anomaly. In an adaptation of this concept, the aural warning processor 20 of the present invention may be further adapted to generate such a tone upon escalation of priority of a detected anomalous condition. As will be appreciated by those of ordinary skill in the art, especially in light of this exemplary description, this latter feature may be of great benefit in preventing a situation where the attention of crewmembers 123, 124 has been diverted from an otherwise closely monitored visual warning device 102 for the handling of a precautionary indicator 108 causing failure of the crewmembers 123, 124 to timely observe and react to a subsequently activated imperative indicator 105. In any case, all of the foregoing features, individually or in any combination, are and should be considered as being within the scope of the present invention.

In any case, as particularly shown in FIG. 3, the host system failure detection circuits 91 of a host system 88, such as the exemplary helicopter 89, typically have associated therewith a circuit interface 92 for electrical communication with other subsystems of the host system 88. In particular, the circuit interface 92, which as shown in FIG. 3 may simply comprise a cable bundle or the like, is generally adapted for connecting the host system failure detection circuits 91 of the host system 88 to a provided visual warning device 102, such as, in the case of the exemplary helicopter 89, the depicted annunciator panel 103. To this end, the circuit interface 92 generally further comprises one or more electrical connectors 93 such as, for example, DB-25 or like type jacks or plugs at the terminal end of the cable bundle. Similarly, the annunciator panel 103, or other visual wanting device 102, also generally has associated therewith a device interface 113, which like the circuit interface 92 for the host system failure detection circuits 91 may simply comprise a cable bundle. As will be appreciated by those of ordinary skill in the art, the cable bundle forming the device interface 113 for the host system visual warning device 102 generally further comprises one or more electrical connectors 114 adapted for connection with the electrical connectors 93 provided at the circuit interface 92 from the host system failure detection circuits 91.

In the ordinary course of use, the electrical connectors 93 provided at the circuit interface 92 from the host system failure detection circuits 91 are directly connected to the electrical connectors 114 provided at the device interface 113 to the host system visual warning device 102. As previously noted, however, it is contemplated that the aural warning processor 20 of the present invention will generally be integrated with a preexisting host system 88 in order that the integrated aural warning processor may utilize various preexisting subsystems of the host system 88. To this end, additional bundled interface cabling 97 is provided in connection with the aural warning processor 20 of the present invention. In particular, as shown in FIG. 3, one or more Y-cables 98 (also commonly referred to as splitter cables or Y-splitter cables) are interposed the electrical connectors 93 of the circuit interface 92 from the host system failure detection circuits 91 and the electrical connectors 114 of the device interface 113 to the host system visual warning device 102. As will be appreciated by those of ordinary skill in the art, whereas an ordinary bundled cable provides electrical interconnectivity between a pair of electrical connectors, each depicted Y-cable provides electrical interconnectivity between three electrical connectors 99, 100, 101 such that both a first connector 99 and a second connector 100 are identically in electrical communication with a third electrical connector 101. As shown in FIG. 3, the first connector 99 of each provided Y-cable 98 is, according to the preferred method of integration for the aural warning processor 20 of the present invention, connected to a connector 22, 23 of the system interface 21 of the aural warning processor 20 while the second connector 100 of each provided Y-cable 98 is connected to a connector 114 of the of the device interface 113 to the host system visual warning device 102 and the third connector 101 of each provided Y-cable 98 is connected to a connector 93 of the circuit interface 92 from the host system failure detection circuits 91. In this manner, as will be appreciated by those of ordinary skill in the art, the aural warning processor 20 of the present invention is integrated with the host system 88 by the establishment of an electrical connection shared with the otherwise provided visual warning device 102 of the host system 88.

In addition to providing the described shared connection, however, it is noted that the most preferred implementation of the aural warning processor 20 of the present invention further contemplates that the provided Y-cables 98 be utilized as a convenient point of connection to the aural warning processor 20 of electrical power, circuit ground and control inputs as well as for a convenient point of connection from the aural warning processor 20 of audio output. For example, as shown in FIG. 3, one or more host system power sources 94, 95 and a host system circuit ground connection 96 may be made available for use by the aural warning processor 20 by terminating electrical connections from the sources 94, 95 and ground 96 in a connector 93 of the circuit interface 92 from the host system failure detection circuits 91, thereby making power and ground available to the aural warning processor 20 through the previously described Y-cable interconnection of the system interface 21 of the aural warning processor 20 and the circuit interface 92 from the host system failure detection circuits 91. Similarly, as also shown in FIG. 3, an audio input line 117 for an intercommunication subsystem 115 otherwise integrated into the host system 88 may be terminated in a connector 93 of the circuit interface 92 from the host system failure detection circuits 91, thereby enabling the audio output line 82 from the audio output generation circuit 62 (as previously described with reference to FIG. 4) to be connected through the system interface 21 of the aural warning processor 20 to the intercommunication subsystem 115 of the host system 88. Finally, it is noted that the visual warning device 102 of a host system 88 will often be provided with one or more user control inputs related to the visual warning device 102 and/or its function in connection with host system failure detection circuits 91. For example, the annunciator panel 103 of the exemplary helicopter 89 is depicted in FIG. 2 as being provided with a reset switch 111 and a test switch 112. To the extent that such user control inputs 111, 112 are otherwise interconnected with the host system failure detection circuits 91 through the previously described connection between the circuit interface 92 of the host system failure detection circuits 91 and the device interface 113 of the host system visual warning device 102, the provided Y-cables 98 may be and are preferably further utilized to extend connectivity of the user control inputs 111, 112 through the system interface 21 of the aural warning processor 20 for use therein, as will be described in greater detail further herein.

As will be appreciated by those of ordinary skill in the art, however, it is not critical to the present invention that the foregoing implementation is fully carried out in the described manner. For example, those of ordinary skill in the an will recognize that some described benefit may be had by splicing various connections into the Y-cables 98 independent of and remote to the host system failure detection circuits 91. In particular, while desirable for the reasons previously set forth, it is nonetheless not considered critical to the present invention that any one of the described host system power sources 94, 95, host system circuit ground connection 96 or the input line 117 for the intercommunication subsystem 115 be connected through the circuit interface 92 of the host system failure detection circuits 91 or, for that matter, through or related in any manner to the host system failure detection circuits 91. Likewise, any number of additional connectors and/or dedicated interfaces may be provided in any particular implementation as warranted by such factors as cable routing considerations, installation constraints and the like, all of which are well known to those of ordinary skill in the art. Finally, it should be appreciated that, as is typical in complex systems of the general nature of the described host systems 88, the physical interconnection of the subsystems implicated in the present invention will in general require the provision of complexly bundled cabling, which will likely involve a high number of connectors widely dispersed over the length of the cable bundle.

As previously discussed, the only critical requirements for the interconnection of implicated subsystems are those actually necessary for integration of the aural warning processor 20 with a preexisting host system 88 such that shared utilization by the aural warning processor 20 of various preexisting subsystems of the host system 88 is enabled, including most particularly, utilization of the signals output from the host system failure detection circuits 91. That said, however, it is noted that one particularly advantageous aspect of the most preferred embodiment is the previously mentioned connection of the audio output line 82 from the audio output generation circuit 62 to an intercommunication subsystem 115 otherwise integrated into the host system 88. As will be appreciated by those of ordinary skill in the art, host systems 88 for which the aural warning processor 20 of the present invention is most particularly suited generally have associated therewith an intercommunication subsystem 115 providing many advanced features, the uses of such advanced features being particularly beneficial in the most preferred implementations of the present invention. For example, the helicopter 89 previously described as being generally exemplary of these type of host systems 88 is provided with an intercommunication subsystem 115 comprising an advanced integrated intercommunication control system 116 such as, for example, the Model A301-6 Intercommunication System Control unit as is commercially available from Andrea System LLC of Farmingdale, N.Y. and well-known in the art for its widespread utilization on and in connection with Bell Textron helicopter models 206/205/HUEY II/212/412. As will be appreciated by those of ordinary skill in the art, this type of intercommunication control subsystem 116 is generally adapted to selectively combine multiple audio sources into a composite audio output signal, which audio output signal may then be selectively directed to one or more audio outputs 118.

As particularly shown in FIGS. 1 and 3, the audio signal from the aural warning processor 20 of the present invention may readily be routed to an audio input line 117 for the intercommunication control subsystem 116, which audio input line 117 may be any one of a provided plurality of individually switched audio input lines and/or a provided direct input line specifically adapted for inputting warning signals to the composite audio mixer of the intercommunication control subsystem 116. As will be recognized by those of ordinary skill in the art, utilizing the preexisting facilities of the exemplary intercommunication control subsystem 116 in the manner described as most preferred for the present invention enables aural warnings generated through the aural warning processor 20 of the present invention to be delivered to crewmembers 123, 124 without concern for the technical complexities generally associated with the electrical mixing of audio signals and without requiring crewmembers 123, 124 to deviate from their ordinary practices in the general operation of the host system 88. In particular, utilization according to the preferred method of the present invention of the preexisting audio input and mixing facilities of the depicted exemplary intercommunication control subsystem 116 enables the audio signal carried through the audio output line 82 from the aural warning processor 20 to be readily and reliably mixed into and delivered with other audio signals otherwise communicated between the crewmembers 123, 124 through the audio outputs 118 provided with the intercommunication control subsystem 116.

According to this most preferred implementation of the present invention, it is particularly noted that the resulting composite audio is automatically delivered to the crewmembers 123, 124 as would be other operational communications. For example, a first crewmember 123 monitoring audio communications through a speaker 119 such as may be conventionally located within or adjacent the overhead control group 130 or in another appropriate area of the cockpit 122 of the helicopter 89, which is generally representative of the typical crew space of a host system 88, will without deviation from ordinary operational practice also receive any audio signal output from the aural warning processor 20 of the present invention through the same preexisting speaker 119. Likewise, a second crewmember 124 monitoring audio communications through headphones 121 plugged into a headphone connector 120 conventionally provided as an audio output 118 from the depicted exemplary intercommunication control subsystem 116 will without deviation from ordinary operational practice also receive any audio signal output from the aural warning processor 20 of the present invention through the same preexisting headphones 121.

Still further, it is noted that the intercommunication subsystem 115 of a typical host system 88 will typically have associated and integrated therewith many standard or advanced controls. For example, the exemplary intercommunication control subsystem 116 as herein described includes the provision for individual selection and mixing of up to ten separate audio input lines. Additionally, the selection controls for the provided audio input lines, as well as master volume controls and the like, are as is conventional located on the panel of the intercommunication control subsystem 116, which is generally positioned within the cockpit 122 of the helicopter 89 conveniently within reach of the crewmembers 123, 124 such as, for example, within a communications console 126. Although it is possible in a minimal implementation of the present invention to provide as part of or in connection with the aural warning processor 20 dedicated or otherwise separate audio output devices, those of ordinary skill in the art will recognize in light of this exemplary discussion that many particular advantages are to be had through an implementation utilizing preexisting facilities of an otherwise provided intercommunication subsystem 115.

For example, utilization of the described preexisting selection and volume controls prevents further clutter of the generally crowded communications console 126, instrument panel 127 and/or overhead control group 130, thereby preventing further multiplication of the number of subsystems as must be managed by the crewmembers 123, 124. Additionally, utilization in particular of the described preexisting selection control allows for the selective temporary silencing of an aural warning message generated by the aural warning processor 20 without the addition of a separate dedicated control or other implementation complexity. Still further, utilization in the described manner of such controls directly contributes to the preferred manner of integration of the aural warning processor 20 with a preexisting host system 88.

As has now been described in detail, the most preferred implementation of the aural warning processor 20 of the present invention generally comprises a fully integrated unit such that the aural warning processor 20 may be readily integrated into a host system 88 with all post-mounting installation being accomplished solely via electrical connections made through the system interface 21. As has also been described in detail, the most preferred implementation of the system interface 21 is adapted for and provides off-system electrical connectivity to and/or from the aural warning processor 20, including electrical power and ground input connections, abnormal condition signal input connections, test and reset command signal input connections and at least one audio signal output connection. While in accordance with further objects of the present invention the aural warning processor 20 of the present invention is as much as is possible adapted for generic deployment across a wide range of host systems 88, at least some implementation details will necessarily be driven by the peculiarities of the particular host system 88 with which the deployed aural warning processor 20 is integrated.

For example, it is has been previously mentioned that the system interface 21 of the aural warning processor 20 may be utilized to make one or more host system power sources 94, 95 available for the use of the aural warning processor 20. Those of ordinary skill in the art will appreciate that, as with any implemented electrical device, the appropriate number and electrical characteristics of the host system power sources 94, 95 made available for the aural warning processor 20 will depend upon the electrical needs of the components implemented therein. To this end, the electrical needs of such implemented components as the microcontroller 56, the multiplexers 27, 34, 43 of the warning signal monitoring circuit 26 and the integrated message playback circuit 62 may dictate that a first host system power source 94 be selected to provide 5-Vdc electrical power through the system interface 21 to a common 5-Vdc power bus 85 implemented within the aural warning processor 20. Likewise, similar considerations may dictate that a circuit ground connection 96 from the host system 88 be extended through the system interface 21 to a common ground bus 87 for the aural warning processor 20.

In the most basic implementations of the present invention, the common 5-Vdc power bus 85 provides a 5-Vdc power supply to the power input 57 of the microcontroller 56, the power inputs 28, 35, 44 of the respective multiplexers 27, 34, 43, the digital and analog power inputs 64, 66 of the integrated message playback circuit 62 and to any logical input of such components as may require 5-Vdc power for selection of a desired “high” state. Likewise, common ground bus 87 provides ground to the ground 58 of the microcontroller 56, the grounds 29, 36, 45 of the respective multiplexers 27, 34, 43, the digital and analog grounds 65, 67 of the integrated message playback circuit 62 and to any logical input of such components as may require grounding for selection of a desired “low” state. As will be appreciated by those of ordinary skill in the art, however, a particular implementation of the aural warning processor 20 of the present invention may also include on-system power conditioning circuits and/or isolation circuits for separating digital and analog sources or the like. In any case, the manner of implementation of any or all of these additions is generally within the ordinary skill in the art and any implementation of the aural warning processor 20 including such extensions should be considered within the scope of the present invention.

It should also be noted, however, that the selection of the implemented components may well be driven by the subsystems of the host system 88 that are available for the use of the aural warning processor 20 in accordance with the objects of the present invention. For example, it may be that the specific intercommunication control subsystem 116 available in the host system 88 for use of the aural warning processor 20 is adapted for optimized for the input of audio signals of greater than 5-Vdc. As particularly shown in FIG. 4B, the particular implementation of the aural warning processor 20 may therefore require implementation of an audio amplifier circuit 84, which, n turn, may required that a 28-Vdc power bus 86 be provided within the aural warning processor 20. In this case, the power requirements of the aural warning processor 20 as specifically driven by the available subsystems of the host system 88 dictate that a second host system power source 95 be selected to provide 28-Vdc electrical power through the system interface 21 to a common 28-Vdc power bus 86 implemented within the aural warning processor 20.

Still further, the reliable operation of an aural warning processor 20 integrated, according to the teachings of the present invention, into a particular host system 88 will always require at least consideration of the characteristics of the particular electronic components adjacent the system interface 21. In many if not most cases, some type of isolation circuit 24 will be necessary in order to prevent interference by components on one side of the system interface 21 with components on the other. While the particular implementation of any such isolation circuit 24 will be highly dependent on the exact characteristics of the implicated components, it is noted that the design and use of such circuits is well within the ordinary skill in the art and, in fact, may be relatively straightforward. For example, as particular shown in FIG. 4A, such an isolation circuit 24 may simply comprise a number of diodes 25 interposed the various signal line between the pull-up resistors 41 associated with the multiplexers 27, 34 of the warning signal monitoring circuit 26 and the connectors 22, 23 of the system interface 21. As will be understood by those of ordinary skill in the art, the provided diodes 25 are thereby arranged to isolate the host system failure detection circuit 91 and host system visual warning device 102 from any accumulation of leakage current or other potentially deleterious effects of the warning signal monitoring circuit 26 and/or the control circuit 55.

Although those of ordinary skill in the art will recognize many substantial equivalents, alternatives, extensions and modifications, especially in light of the exemplary foregoing and following discussions, Applicant now sets forth details of one preferred method for use of the aural warning processor 20 of present invention. While proceeding with a view toward providing such an exemplary description as may generally inform implementation of the aural warning processor 20 in any appropriate host system 88, Applicant particularly addresses the following discussion to an implementation of the aural warning processor 20 in connection with the helicopter 89, which has previously been described as being generally representative of the wider genus of such host systems 88. To this end, the following discussion is narrowly tailored to the specific subsystems as are generally provided on or in connection with the exemplary helicopter 89 in order to maximize clarity in the presentation. It should be understood, however, that the discussion is exemplary only and the concepts herein embodied are specifically intended for extrapolation within the ordinary skill in the art for general application to the broader class of all host systems 88, all such applications being regarded as within the scope of the present invention as defined only by the claims appended hereto.

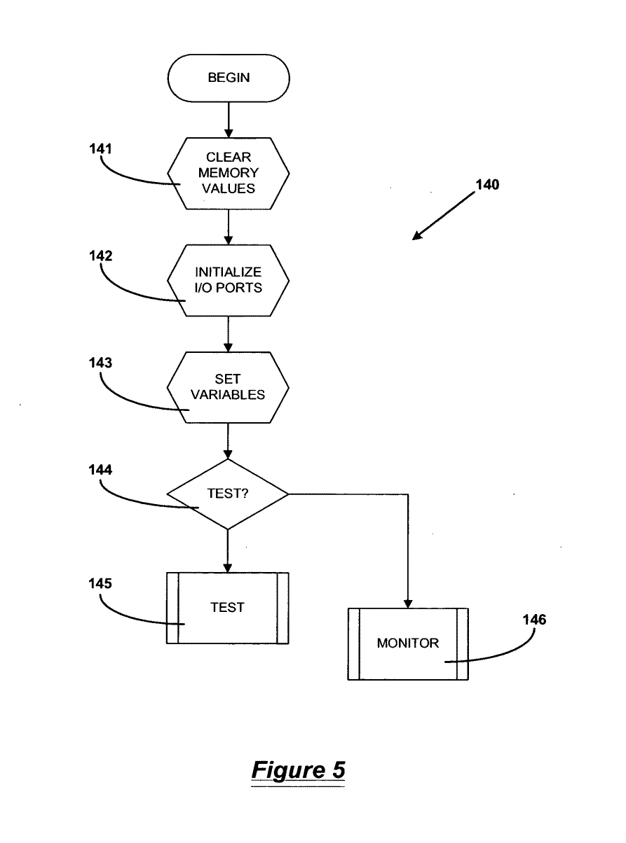

Referring now to FIG. 5, it is shown that in the exemplary preferred method for use of the aural warning processor 20 of the present invention, a main program 140 is executed upon power on of the implemented microcontroller 56. Because, as has been previously discussed, the microcontroller 56 is advantageously provided with built in power-on reset functionality, the microcontroller 56 will start in a stable state at the correct program location upon application of electrical power to its power input 57. As a result, in the most preferred implementation of the present invention, no additional user control or startup circuitry is required. It is noted, however, that in implementations of the aural warning processor 20 comprising a control circuit 55 lacking such advantageous functionality, the implementation of any required adjustments or additional steps is well within the ordinary skill in the art.

In any case, the main program 140, which is statically stored in the integrated program memory space previously discussed as being advantageously provided with the implemented microcontroller 56, begins by attending to various housekeeping activities as are necessary to ensure that further program flow is executed from a known and stable state. In particular, the main program 140 starts by clearing memory values (step 141) from the integrated data memory space, also previously discussed as being advantageously provided with the implemented microcontroller 56, and then initializing the I/O ports 59 of the microcontroller 56 (step 142). The main program 140 then continues to set program variables to their respective initial values (step 143), as determined within the ordinary skill in the art as part of the actual programming of the microcontroller 56. With the microcontroller 56 and main program 140 thus initialized, the main program 140 then continues to begin interaction through the microcontroller 56 with other components of the aural warning processor 20 and their associated data values and/or logic levels.

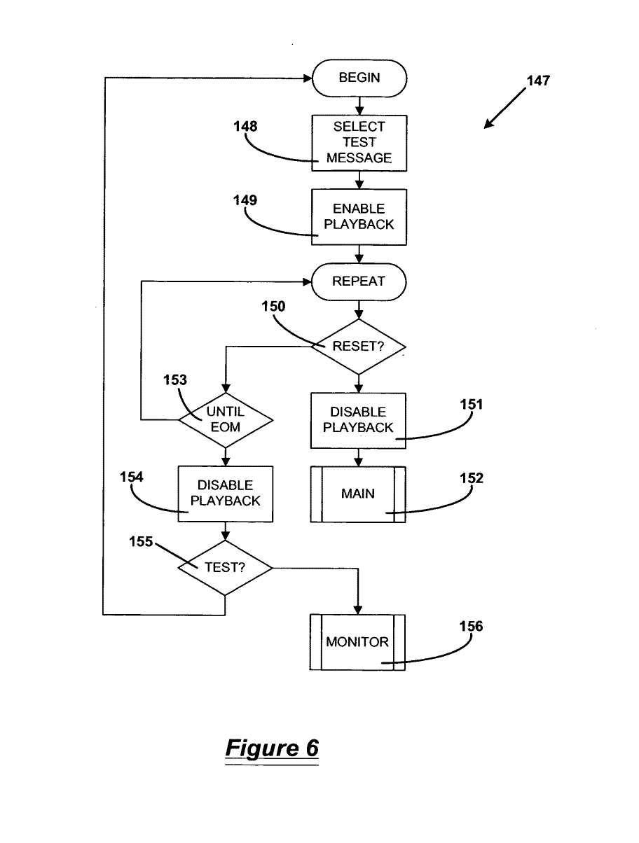

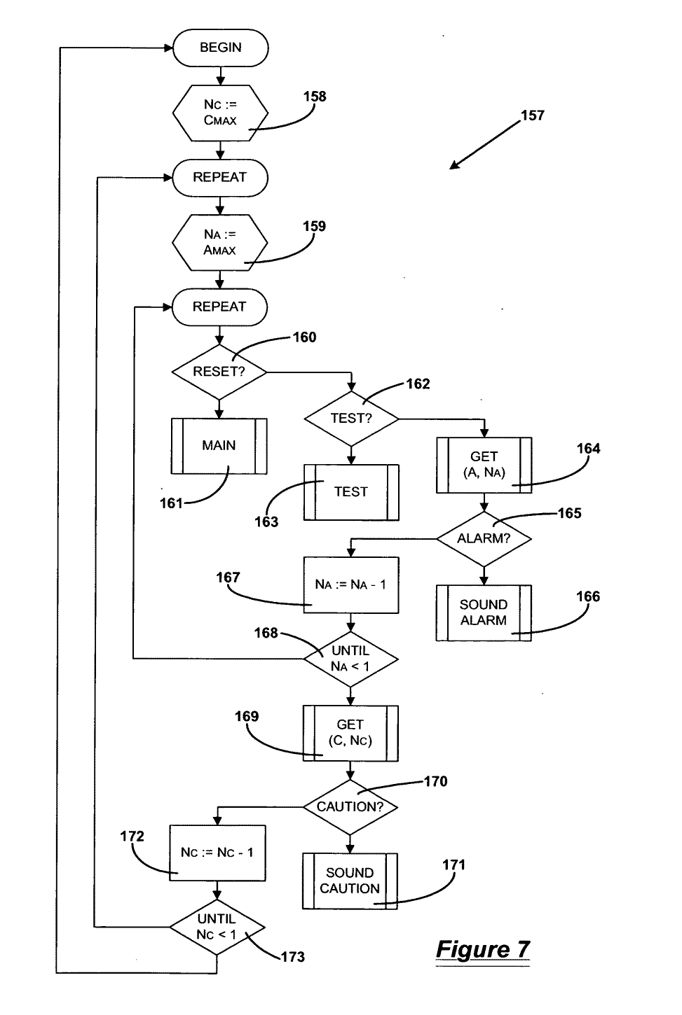

In particular, at this point in the execution of the main program 140, Applicant finds it appropriate to evaluate the state of the test switch 112 (step 144), which, as previously discussed, is in the exemplary preferred embodiment located on the front of the annunciator panel 103 located on the instrument panel 127 or other appropriate location within the cockpit 122 of the helicopter 89. As will be appreciated by those of ordinary skill in the art, the test switch 112, which may simply comprise an ordinary single pole, single throw (“SPST”) electrical switch, is ordinarily adapted to cause illumination of the indicator lights 104 provided on the annunciator panel 103 in order that one or more of the crewmembers 123, 124 of the helicopter 89 may conduct a visual inspection to ensure that all of the indicator lights 104 appear in working order. As previously described, however, the signal from the test switch 112 is for the present invention in electrical communication through a connector 22 of the system interface 21 of the aural warning processor 20 to an I/O port 59 of the implemented microcontroller 56. As has also been previously described, the microcontroller 56 has the capability, whether through the advantageously built in interrupt capability or otherwise, to directly monitor the state of the test switch 112 at any time deemed necessary under the implemented program flow. If the evaluation (step 144) of the test switch 112 returns true, indicating that the test switch 112 is at that time active, the main program 140 branches to execute a test routine 147 (step 145), one example of which is detailed with reference to FIG. 6. If, on the other hand, the evaluation (step 144) of the test switch 112 returns false, indicating that the test switch 112 is at that time inactive, the main program 140 branches to execute a monitor routine 157 (step 146), the preferred embodiment of which is detailed with reference to FIG. 7, wherein the electrical signals output from the host system failure detection circuits 91 are repeatedly monitored, as will be described in greater detail further herein, to determine whether any such signal is indicative of an abnormal condition.

Referring now to FIG. 6, there is shown a simple test routine 147 such as may be called for execution from the main program 140 of FIG. 5, as previously described, or from elsewhere in the overall program flow, as will be better understood further herein. As shown in FIG. 6, the exemplary simple test routine 147 begins with the selection by the microcontroller 56 of a test message to be played by the implemented integrated message playback circuit 63 (step 148). In particular, the address location within the integrated message playback circuit 63 for the desired test message, as stored in the program memory space of the microcontroller 56, is output from the microcontroller 56 through the I/O ports 59 of the microcontroller 56 that are assigned to the message address bus 75 connecting the microcontroller 56 to the integrated message playback circuit 63, as has been previously described, thereby establishing the address location for the desired test message on the message address select inputs 74 of the integrated message playback circuit 63.

The address location for the desired test message thus being established on the message address select inputs 74 of the integrated message playback circuit 63, execution of the test routine 147 continues to enable message playback (step 149) in the integrated message playback circuit 63. As previously discussed, the message playback operation of the integrated message playback circuit 63 is enabled by outputting an appropriate logic level signal from the microcontroller 56, as specified by the manufacturer of the integrated message playback circuit 63, through the I/O port 59 of the microcontroller 56 that is assigned to the enable control line 77 connected to the integrated message playback circuit 63, thereby establishing the required logic level on the chip enable input 76 of the integrated message playback circuit 63. The appropriate logic level thus being established on the chip enable input 76 of the integrated message playback circuit 63, the integrated message playback circuit 63 operates for playback of the test message as identified by the address location established on the message address select inputs 74. Although the more narrow details of operation of the implemented message playback circuit 63 are omitted to preserve clarity, it is noted that all such details, which will vary according to the particular audio output generation circuit 62 implemented, will be fully specified by the device manufacturer for the implemented audio output generation circuit 62 and, regardless, are all well within the level of ordinary skill in the art.

In any case, the integrated message playback circuit 63, set up as described in earlier discussions and enabled as described in the foregoing discussion, will at this point in the execution of the test routine 147 operate to output the audio signal for the selected test message through the speaker outputs 81, 83 from the integrated message playback circuit 63. Because, as previously discussed, the integrated intercommunication control system 116 of the helicopter 89 requires a singe-ended, preferably amplified audio signal, the audio signal output from the integrated message playback circuit 63 through the positive speaker output 81 is, as particularly shown in FIG. 4, amplified by the provided audio amplifier circuit 84 and, thereafter, transmitted over the audio output line 82 to a connector 23 of the system interface 21 of the aural warning processor 20. With the system interface 21 of the aural warning processor 20 of the present invention electrically connected as previously described to the various shared subsystems of the helicopter 89, the amplified audio signal is conducted to an audio input line 117 of the integrated intercommunication control system 116 of the helicopter 89. As previously described, the audio signal is then electrically mixed by the integrated intercommunication control system 116 with any other present audio signals and the resulting composite signal is passed through the outputs 118 of the integrated intercommunication control system 116 to an audio device such as, as shown in FIGS. 1 and 3, a speaker 119 installed in the cockpit of the helicopter 89 or headphones 121 worn by a crewmember 124 of the helicopter 89. In any case, at this point the audio signal from the aural warning processor 20 of the present invention will have been converted to and comprise an aural message, which in the case of the described simple test message may be a prerecorded or synthesized voice stating, for example, “AURAL MASTER CAUTION PANEL TEST OKAY.”

At this point in the execution of the test routine 147, with the aural test message being generated and output as described above, Applicant finds it appropriate to evaluate the state of the reset switch 111 (step 150), which, like the test switch 112 and also as previously discussed, is in the exemplary preferred embodiment located on the front of the annunciator panel 103 located on the instrument panel 127 or other appropriate location within the cockpit 122 of the helicopter 89. As will be appreciated by those of ordinary skill in the art, the reset switch 111, which also like the test switch 112 may simply comprise an ordinary single pole, single throw (“SPST”) electrical switch, is ordinarily adapted to enable initiation by a crewmember 123, 124 of a reset process for the host system failure detection circuits 91 ordinarily monitored by the annunciator panel 103 of the helicopter 89. Although beyond the scope of the present invention, it should nonetheless be appreciated that the reset switch 111 will ordinarily be activated by a crewmember 123, 124 for the purpose of clearing an indicated warning following an intervention in response to the warning, thereby returning the monitored host system failure detection circuits 91 and/or any latched outputs therefrom to their original states, which, in turn, enables the crewmembers 123, 124 to recheck the annunciator panel 103 to verify the effectiveness of the intervention. Additionally, the reset switch may me activated by a crewmember 123, 124 upon the suspicion that a warning for some reason has been falsely triggered, thereby enabling verification of the actual existence of an anomalous condition.

In any case, it is desirable that any aural message being generated by and/or output from the aural warning processor 20 of the present invention should upon activation by a crewmember 123, 124 of the reset switch 111 be immediately terminated and that the program flow for control of the aural warning processor 20 should be reinitialized. To this end, as previously described, the signal from the reset switch 111 is for the present invention in electrical communication through a connector 22 of the system interface 21 of the aural warning processor 20 to an I/O port 59 of the implemented microcontroller 56. As has also been previously described, the microcontroller 56 has the capability, whether through the advantageously built in interrupt capability or otherwise, to directly monitor the state of the reset switch 111 at any time deemed necessary under the implemented program flow. If the evaluation (step 150) of the reset switch 111 returns true, indicating that the reset switch 111 is at that time active, the test routine 147 branches to disable message playback (step 151) in the integrated message playback circuit 63, whereafter the test routine 147 terminates and the program flow returns to the beginning of the main program 140 (step 152) for reinitializing of the aural warning processor 20 and continued operation. As will be appreciated by those of ordinary skill in the art, the message playback operation of the integrated message playback circuit 63 is disabled by outputting an appropriate logic level signal from the microcontroller 56, as specified by the manufacturer of the integrated message playback circuit 63, through the I/O port 59 of the microcontroller 56 that is assigned to the enable control line 77 connected to the integrated message playback circuit 63, thereby establishing the required logic level on the chip enable input 76 of the integrated message playback circuit 63. The appropriate logic level thus being established on the chip enable input 76 of the integrated message playback circuit 63, the integrated message playback circuit 63 operates to immediately cease playback of the test message.

If, on the other hand, the evaluation (step 150) of the reset switch 111 returns false, indicating that the reset switch 111 is at that time inactive, the test routine 147 branches to evaluate the state of the end-of-message flag signal (step 153) as output from the end-of-message flag output 78 of the integrated message playback circuit 63. As previously discussed, the end-of-message flag output 78 is advantageously provided on the implemented integrated message playback circuit 63 to positively indicate completion of playback of a particular aural message, thereby preventing inadvertent spillover to an undesired message as well as relieving the microcontroller 56 of having to utilize timing schemes or the like to determine the completion of a message playback. To this end, as previously described, the end-of-message flag signal from the end-of-message flag output 78 of the integrated message playback circuit 63 is in the present invention in electrical communication with the microcontroller 56 through an I/O port 59 of the microcontroller 56 that is assigned to the end-of-message signal line 79 connected to the integrated message playback circuit 63. As has also been previously described, the microcontroller 56 has the capability, whether through the advantageously built in interrupt capability or otherwise, to directly monitor the state of the reset switch 111 at any time deemed necessary under the implemented program flow.

If the evaluation (step 153) of the state of the end-of-message flag signal returns false, indicating that the integrated message playback circuit 63 has not yet completed generation and playback of the previously selected aural message, the test routine 147 loops back to the evaluation (step 150) of the reset switch 111 in order to allow the message playback to continue. If, on the other hand, the evaluation (step 153) of the state of the end-of-message flag signal returns true, indicating that the integrated message playback circuit 63 has fully completed generation and playback of the previously selected aural message, the test routine 147 continues to disable message playback (step 154) in the integrated message playback circuit 63, in the same manner as has been previously described, whereafter the test routine 147 further continues to reevaluate the state of the test switch 112 (step 155), again in the same manner as has been previously described, to determine whether the test switch 112 remains activated. If the reevaluation (step 155) of the test switch 112 returns true, indicating that the test switch 112 remains at that time active (or, has been reactivated and is at that time active), the test routine 147 loops back and again executes from its beginning. If, on the other hand, the reevaluation (step 155) of the test switch 112 returns false, indicating that the test switch 112 is at that time no longer active, the test routine 147 branches to execute the previously mentioned monitor routine 157 (step 156), as described in greater detail further herein.

Before continuing with discussion of the monitor routine 157, however, it is noted that the foregoing discussion of the test routine 147 concerned performance of a very simple test, essentially directed toward determining the apparent working order of the basic components of the aural warning processor 20 and some of the associated subsystems of the host system 89, particularly including, for example, the host vehicle intercommunication subsystem 115 and audio devices 119, 121. While the foregoing discussion focuses on a very simple test, it is further noted that the discussion is exemplary only. To this end, it is still further noted that much more complex tests may be readily implemented, including functional testing of the host system failure detection circuits 91, the indicator lights 104 provided on the annunciator panel 103 and the like. Additionally, it should be appreciated that, with the provision of such tests, the aural warning processor 20 of the present invention may be readily adapted to generate a plurality of test-related messages such as may indicate details regarding detected failures or the like in or related to the host system failure detection circuits 91, the indicator lights 104 provided on the annunciator panel 103 and the like. In any case, all such extensions are in light of this exemplary discussion within the ordinary skill n the art and are considered within the scope of the present invention.

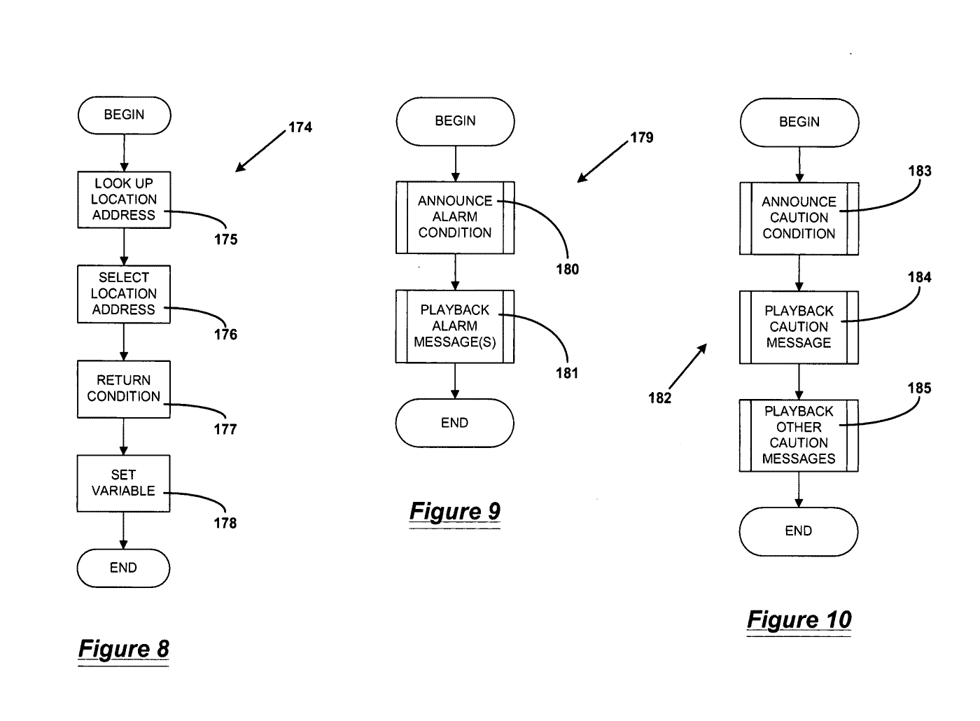

Referring now to FIG. 7, an exemplary monitor routine 157 is shown to generally comprise a continuously repeating program loop particularly adapted, as previously mentioned, to monitor the electrical signals output from the host system failure detection circuits 91, to determine whether any one or more of such signals is indicative of an abnormal condition with respect to the host system 88 and, if so, to cause the generation appropriate aural warning messages alerting the crewmembers 123, 124 of the nature of the anomalous condition. In the exemplary monitor routine 157 as shown in FIG. 7, Applicant details one method by which the monitoring of the host system failure detection circuits 91 may be prioritized in order to give more vigilant attention to anomalous conditions categorized as being more serious than others. Additionally, the depicted embodiment of the monitor routine 157, and the subordinate routines and subroutines thereof, are shown to make extensive use of a get warning status function 174, described in detail further herein with respect to FIG. 8, which is particularly included to exemplify one aspect of how the method categorical prioritization may be robustly implemented and readily adapted to changing requirements. Finally, the depicted embodiment of the monitor routine 157, and the subordinate routines and subroutines thereof, are intended to exemplify at least one method for varying the manner of playback of aural warning messages such that an escalation in severity of detected anomalies is prominently brought to the attention of the crewmembers 123, 124.

With the foregoing highlighted features in mind, the exemplary monitor routine 157 is shown to begin by resetting a caution number variable N_{C} to the maximum number C_{MAX} of caution categorized anomalies for which the aural warning processor 20 is programmed to monitor (step 158) and, thereafter, resetting an alarm number variable N_{A} to the maximum number A_{MAX} of alarm categorized anomalies for which the aural warning processor 20 is programmed to monitor (step 159). Although for purposes of this exemplary description, caution categorized anomalies and alarm categorized anomalies are defined as described previously herein, it should be remembered that this particular categorization scheme is exemplary only and, as previously discussed in detail, many other schemes are possible. As a result, this exemplary discussion should in no manner be taken as limiting of the range of implementations within the scope of the invention, which is limited only by the claims appended hereto. For purposes of the present discussion, however, it is noted that the caution number variable N_{C} and the alarm number variable N_{A} are each a numerical value preferably stored in the integrated data memory space previously discussed as being advantageously provided with the implemented microcontroller 56. Likewise, the number C_{MAX} of caution categorized anomalies and the number A_{MAX} of alarm categorized anomalies are each a numerical constant preferably stored in the integrated program memory space previously discussed as being advantageously provided with the implemented microcontroller 56.

With the monitor routine 157 now initialized, Applicant finds it appropriate to evaluate the state of the reset switch 111 (step 160) and the state of the test switch 112 (step 162) before continuing. Turning then first to the state of the reset switch 111, the state of which is determined in the same manner as has been previously discussed, if the evaluation (step 160) of the reset switch 111 returns true, the monitor routine 157 terminates and the program flow returns to the beginning of the main program 140 (step 161) for reinitializing of the aural warning processor 20 and continued operation in the manner previously described. If, on the other hand, the evaluation (step 160) of the reset switch 111 returns false, the monitor routine 157 branches to carry out the evaluation (step 162) of the test switch 112, the state of which is also determined in the same manner as has been previously discussed. If the evaluation (step 162) of the test switch 112 returns true, the monitor routine 157 terminates and the program flow diverts to the execution of the test routine (step 163) as previously described with respect to FIG. 6. If on the other hand, the evaluation (step 162) of the test switch 112 returns false, the monitor routine 157 continues with the execution of a plurality of nested loops, which as will be better understood in the following discussions, are preferably specifically calculated to implement the highly desired prioritized monitoring scheme of the present invention.

Before further discussion of the details of the exemplary implementation described herein, it is instructive to first generally contemplate several common features of the architecture. First, it will be observed that the implemented architecture makes extensive use throughout of lookup tables in furtherance of the specific object of the present invention to provide a solution that is robust in implementation such that statically provided features, functions or other capabilities may as much as possible remain amenable to tailored or otherwise customized deployments. To this end, Applicant sets forth an architecture that makes extensive use of a get warning status function 174, which is shown throughout the depicted program flow as being a function GET (X, N_{X}) of two variables, wherein the first variable X indicates the prioritization category of a signal output from the host system failure detection circuits 91 and the second variable N_{X} indicates for the output signal an assigned numeric value unique within the category. As will be better understood further herein, the variable N_{X} is, in the preferred implementation of the present invention, an integer value in the range of 1 to the maximum number X_{MAX} of X categorized anomalies for which the aural warning processor 20 is programmed to monitor. While those of ordinary skill in the art will recognize that a single unique value could be utilized for identification of the signals output from the host system failure detection circuits 91, it is noted that utilization of the variable pair X, N_{X} allows functions to be applied to the signals on a sequential basis per prioritization category with the additional advantage that signals may be readily reassigned to a different category and/or reordered within an assigned category without otherwise affecting program flow.

In order to better understand this advantage, it is noted that the preferred implementation of the get warning status function 174, as shown in FIG. 8, begins by looking up the location address (step 175) of the variable pair X, N_{X} for which the function 174 is called, which returns the 5-bit address for the previously described signal selection bus 52 that corresponds to the specific input 31, 38 to the first or second multiplexer 27, 34 of the warning signal monitoring circuit 26 to which is physically connected the (N_{X})^{th} host system failure detection circuit 91 assigned to category X. Because in the preferred implementation of the present invention, the 5-bit address in question is stored in a lookup table in the integrated program memory space provided with the implemented microcontroller 56, it will be appreciated that the initial assignment or later reassignment of signals output from the host system failure detection circuits 91 to any particular category and/or position within an assigned category is a simple orderly and well controlled matter of setting or updating (in the integrated program memory space of the microcontroller 56) the total number X_{MAX} of signals assigned to each category X and, for each signal N_{X} assigned to a category X, setting or updating (also in the integrated program memory space of the microcontroller 56) the 5-bit address for the signal selection bus 52 that corresponds to that signal.

As will be appreciated by those of ordinary skill in the art, the described architecture completely modularizes the prioritization scheme separate and apart from the overall program flow, thereby making it readily possible to integrate the aural warning processor 20 of the present invention into virtually any host system 88 with without regard for what, if any, prioritization scheme may preexist in or in connection with a particular host system 88. Additionally, however, it is further noted that in the preferred embodiment of the present invention an identical architecture is implemented maintaining logical address locations within the implemented integrated message playback circuit 63 of stored aural messages. In this manner, the overall program flow need only be concerned with the single variable pair X, N_{X} when calling for playback of a message and, by utilizing a lookup table for determination of the logical address locations, initial deployment and/or later updates to the recorded messages is easily handled as is versioning, such as, for example, may be required to accommodate multiple languages.

Returning then to FIG. 7 and the monitor routine 157 thereof, execution of the previously mentioned plurality of nested loops is detailed, describing in particular how a prioritized monitoring scheme is implemented by evaluating all of the signals output from every alarm-categorized host system failure detection circuit 91 each time a single signal output from a caution-categorized host system failure detection circuit 91 is evaluated, thereby ensuring that the aural warning processor 20 produces an aural warning for a caution-categorized anomaly only if there exists at that time no alarm-categorized anomaly, which as previously discussed would take precedence over a caution-categorized anomaly. In any case, the monitor routine 157 as last herein addressed continues by calling the get warning status function 174 of FIG. 8 for the then current alarm number variable pair A, N_{A} (step 164). As previously discussed in greater detail, the get warning status function 174 then begins by looking up the location address (step 175) corresponding to the current value of the variable pair A, N_{A}, which returns the 5-bit address for the previously described signal selection bus 52 that corresponds to the specific input 31, 38 to the first or second multiplexer 27, 34 of the warning signal monitoring circuit 26 to which is physically connected the (N_{A})^{th} host system failure detection circuit 91 assigned to the alarm category.

Continuing, the get warning status function 174 then directs the microcontroller 56 to establish the retrieved 5-bit address on the signal selection bus 52 (step 176) by outputting the appropriate logic level signals for the desired 5-bit address through the I/O ports 59 of the microcontroller 56 that are assigned to the signal selection bus 52 connected to the warning signal monitoring circuit 26. With the warning signal monitoring circuit 26 thus setup to convey the desired signal from the host system failure detection circuits 91 to the microcontroller 56, the get warning status function 174 continues by directing the microcontroller 56 to determine whether the signal corresponding to variable of interest A, N_{A} presented by the host system failure detection circuits 91 through the system interface 21 to the aural warning processor 20 and conveyed therein to the microcontroller 56 through the I/O port 59 of the microcontroller 56 that is assigned to the data output 51 from the warning signal monitoring circuit 26 is indicative of an abnormal condition with respect to the host system 88 (step 177). Upon making the required determination, the get warning status function 174 concludes by setting the returned warning status variable to either true or false (step 178) indicating, if true, that an anomalous condition exists or, if false, that no anomalous condition was detected.

Upon return of the get warning status function 174 as called (step 164) for the current alarm number variable pair A, N_{A}, the monitor routine 157 then proceeds to evaluate the warning status for the then current alarm number variable pair A, N_{A} (step 165). If the evaluation (step 165) of the current alarm number variable pair A, N_{A} returns true, indicating that an alarm-categorized anomalous condition was detected through the previously called get warning status function 174, the monitor routine 157 terminates for execution of a sound alarm routine 179 (step 166), as described in detail further herein. If, on the other hand, the evaluation (step 165) of the current alarm number variable pair A, N_{A} returns false, indicating that no alarm-categorized anomalous condition was detected through the previously called get warning status function 174, the monitor routine 157 branches to decrement current alarm number variable N_{A} by one (step 167) and then evaluates the newly decremented alarm number variable N_{A} (step 168) to determine whether every alarm-categorized signal from the host system failure detection circuits 91 has been assessed for the presence of an anomalous condition.

If the evaluation (step 168) of the then current alarm number variable N_{A} returns false, indicating that one or more alarm-categorized signals from the host system failure detection circuits 91 remain to be assessed for the presence of an anomalous condition, the monitor routine 157 loops back for further assessment. Although those of ordinary skill in the art will recognize that the monitor routine 157 could loop back to the previously called (step 164) get warning status function 174, the preferred implementation of the present invention loops slightly farther back in order that opportunity may be had for once again evaluate the state of the reset switch 111 (step 160) and the state of the test switch 112 (step 162). In any case, however, it is noted that unless there is determined an alarm-categorized anomaly, in which case the loop will as previously mentioned exit with termination of the monitor routine 157 for execution (step 166) of the sound alarm routine 179, the value of the alarm number variable N_{A} will continue to be decremented (step 167) until eventually the evaluation (step 168) of the then current alarm number variable N_{A} returns true, indicating that every alarm-categorized signal from the host system failure detection circuits 91 has been assessed for the presence of an anomalous condition.

Once the evaluation (step 168) of the then current alarm number variable N_{A} returns true, the monitor routine 157 branches to call the previously detailed get warning status function 174 for the then current caution number variable pair C, N_{C} (step 169). Upon return of the get warning status function 174 as called (step 169) for the current caution number variable pair C, N_{C}, the monitor routine 157 then proceeds to evaluate the warning status for the then current caution number variable pair C, N_{C} (step 170). If the evaluation (step 170) of the current caution number variable pair C, N_{C} returns true, indicating that a caution-categorized anomalous condition was detected through the previously called get warning status function 174, the monitor routine 157 terminates for execution of a sound caution routine 182 (step 171), as described in detail further herein. If, on the other hand, the evaluation (step 170) of the current caution number variable pair C, N_{C} returns false, indicating that no caution-categorized anomalous condition was detected through the previously called get warning status function 174, the monitor routine 157 branches to decrement current caution number variable N_{C} by one (step 172) and then evaluates the newly decremented caution number variable N_{C} (step 173) to determine whether every caution-categorized signal from the host system failure detection circuits 91 has been assessed for the presence of an anomalous condition.

If the evaluation (step 173) of the then current caution number variable N_{C} returns false, indicating that one or more caution-categorized signals from the host system failure detection circuits 91 remain to be assessed for the presence of an anomalous condition, the monitor routine 157 loops back for further assessment. In accordance with the preferred implementation of a prioritization scheme, however, it is noted that the loop back at this stage of processing takes the monitor routine 157 to the point of resetting the alarm number variable N_{A} to the maximum number A_{MAX} of alarm categorized anomalies for which the aural warning processor 20 is programmed to monitor (step 159). The monitor routine 157 then evaluates again the state of the reset switch 111 (step 160) and the state of the test switch 112 (step 162) and, unless diverted as a result of one of these evaluations, continues to evaluate (steps 164 et seq.) all of the signals output from every alarm-categorized host system failure detection circuit 91 with the previously described evaluation loop. Unless there is determined an alarm-categorized anomaly, in which case the loop will as previously discussed exit with termination of the monitor routine 157 for execution (step 166) of the sound alarm routine 179, the value of the alarm number variable N_{A} will once again eventually decrement to zero, enabling the monitor routine 157 to once again branch to call the previously detailed get warning status function 174 for the newly decremented current caution number variable pair C, N_{C} (step 169). Similar to the case of the loop for evaluation of alarm-categorized anomalies, however, it is noted that unless there is determined an alarm-categorized anomaly, causing the monitor routine 157 to terminate for execution (step 166) of the sound alarm routine 179, or there is determined a caution-categorized anomaly, causing the monitor routine 157 to terminate for execution (step 171) of the sound caution routine 182, the value of the caution number variable N_{C} will continue to be decremented (step 172) until eventually the evaluation (step 173) of the then current caution number variable N_{C} returns true, indicating that every caution-categorized signal from the host system failure detection circuits 91 has been assessed for the presence of an anomalous condition, in which case the monitor routine 157 loops back and again executes from its beginning.

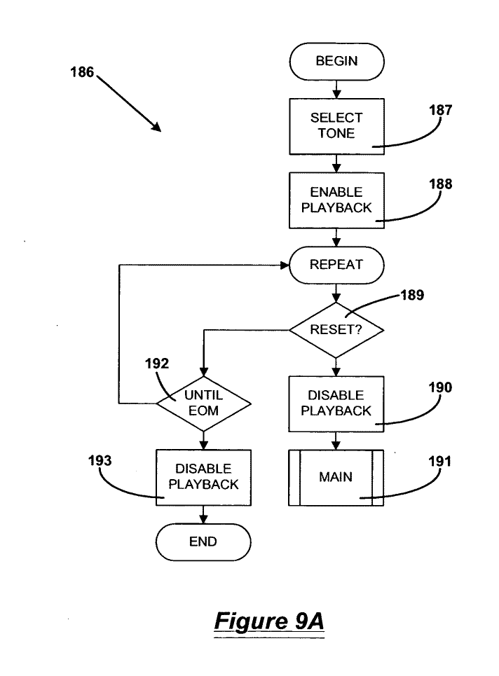

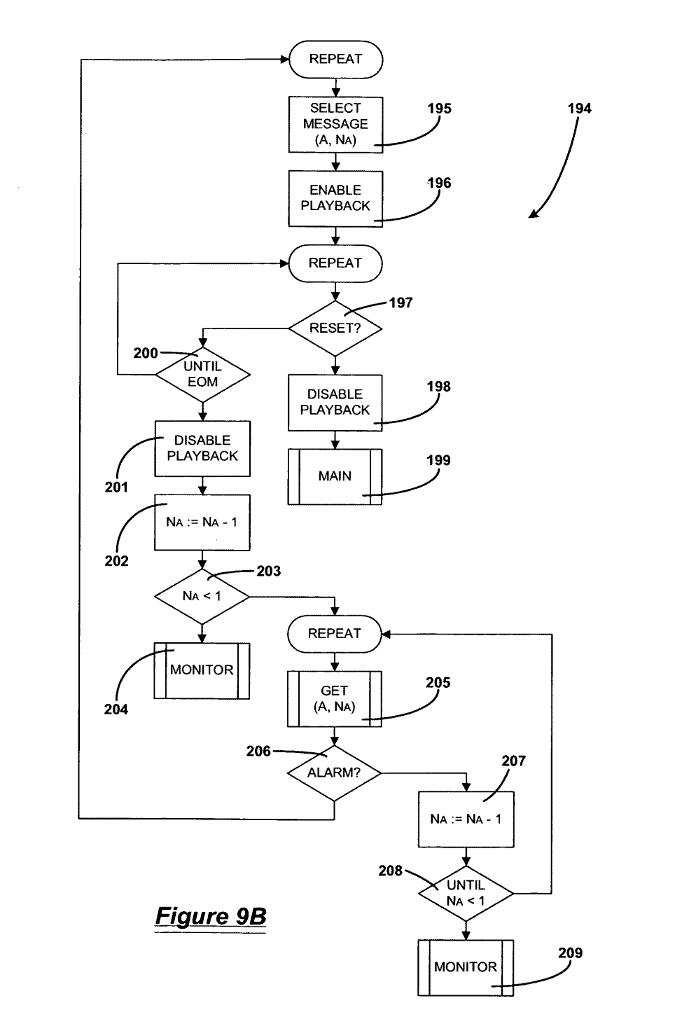

As previously mentioned, the monitor routine 157 exits to a sound alarm routine 179 upon detection of the presence of an alarm-categorized anomalous condition and, similarly, exits to a sound caution routine 182 upon detection of the presence of a caution-categorized anomalous condition. As shown in FIG. 9, the preferred implementation of the sound alarm routine 179 for the present invention generally comprises the sequential execution of an announce alarm condition subroutine 186 (step 180) followed by execution of a playback all alarm messages subroutine 194 (step 181). As will be better understood further herein, the announce alarm condition subroutine 186 is adapted to enable generation by the aural warning processor 20 of an aural tone designed to command immediate attention such as, for example, an unmodulated or modulated single audio frequency or warble of plurality of unmodulated or modulated audio frequencies, with or without interposed periods of silence, or any combination thereof, which, as will be appreciated by those of ordinary skill in the art, have the general characteristic of being extremely attention getting. As will be appreciated in light of the detailed discussion to follow, the program flow of the exemplary sound alarm routine 179 generally limits execution (step 180) of the announce alarm condition subroutine 186 to the period immediately following the first detection within any one execution of the monitor routine 157 of an alarm-categorized anomaly. In this manner, the announce alarm condition subroutine 186 is particularly adapted to draw attention to the escalation of a hazardous condition without otherwise becoming a distraction from attending to previously detected hazardous conditions.

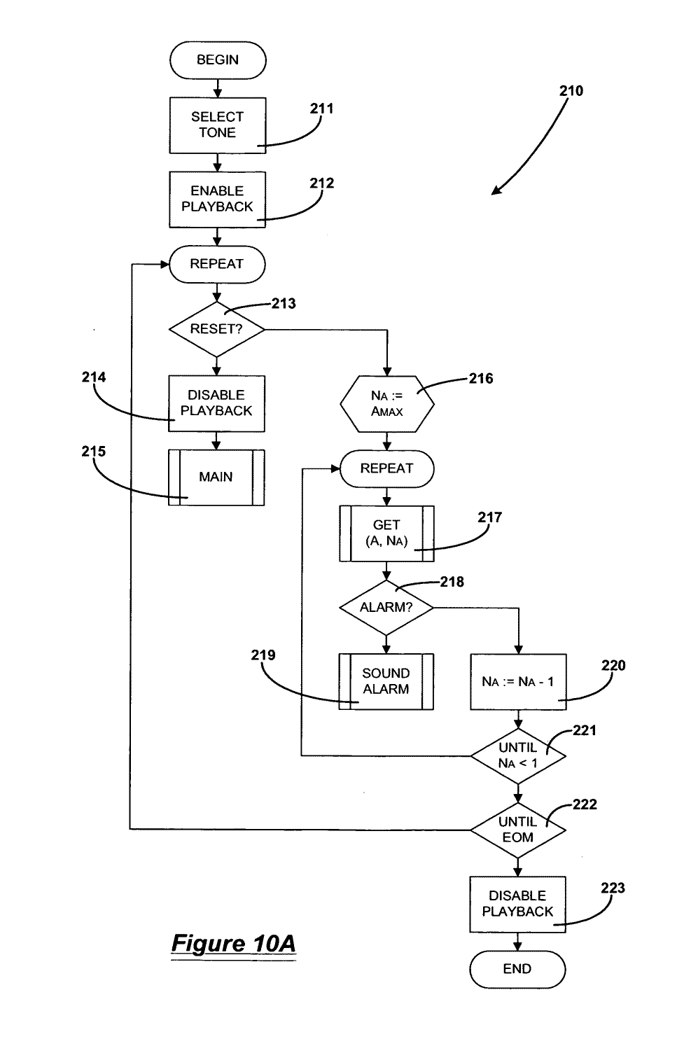

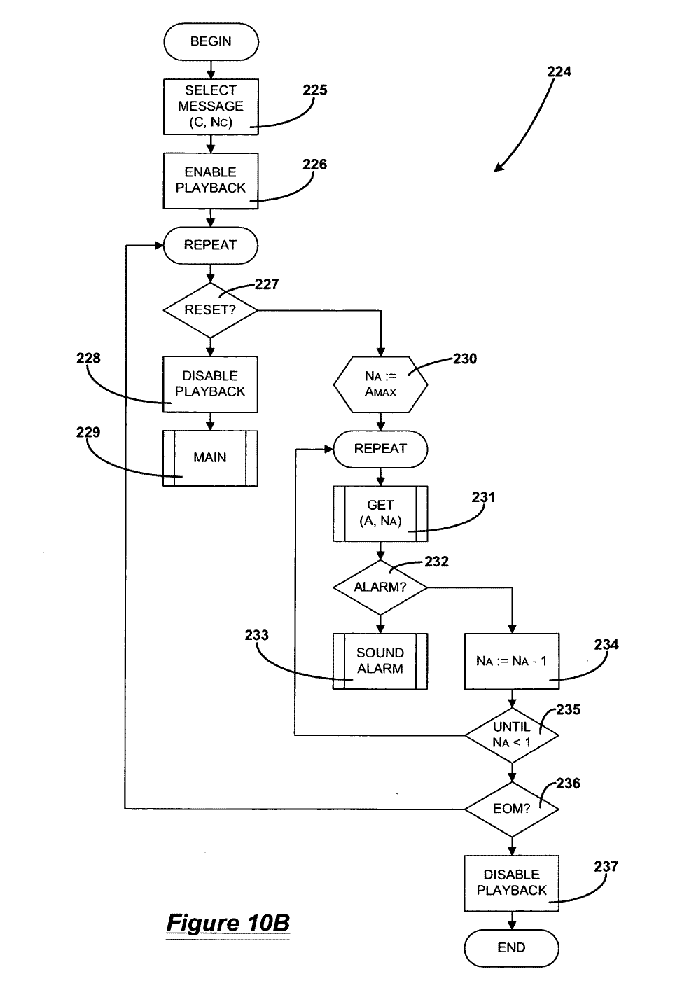

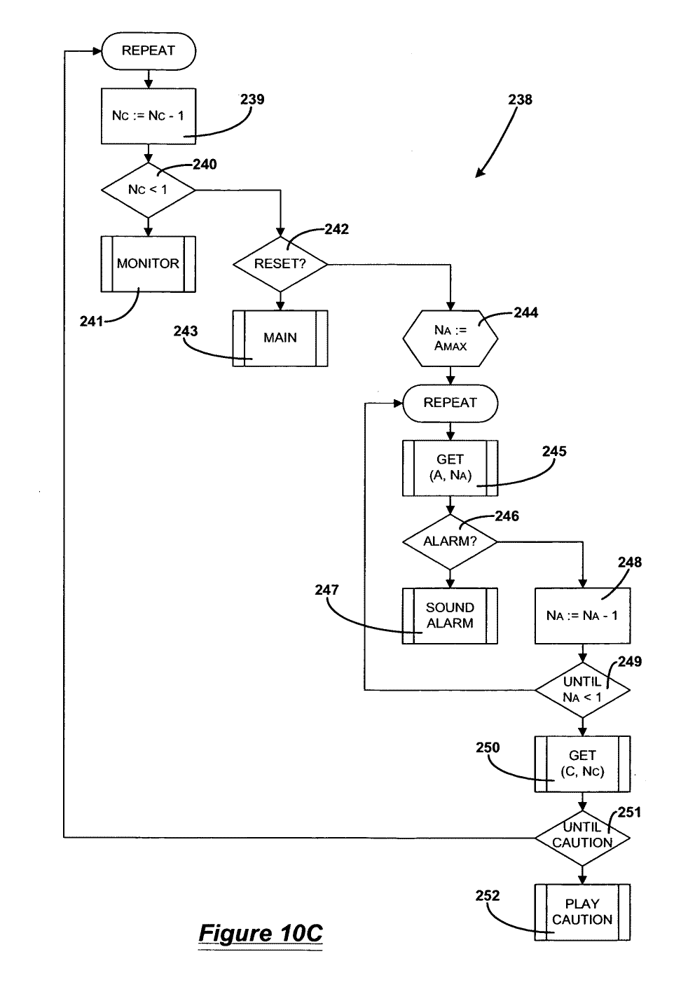

As shown in FIG. 10, the preferred implementation of the sound caution routine 182 for the present invention generally comprises the sequential execution of an announce caution condition subroutine 210 (step 183) followed by execution of a playback caution message subroutine 224 (step 184) and an additional caution determination subroutine 238 (step 185). Although, as also will be better understood further herein, the announce caution condition subroutine 210 is adapted to enable generation by the aural warning processor 20 of an aural tone designed to command attention, it will be appreciated by those of ordinary skill in the art that in order to increase the impact of the announce alarm condition subroutine 186, the described announce caution condition subroutine 210 may be omitted or may be implemented to sound a tone message distinctively less impactful than the tone message associated with the announce alarm condition subroutine 186. In any case, if implemented, the announce caution condition subroutine 210 is preferably limited by the program flow of the exemplary sound alarm routine 179 to execution (step 183) only in the period immediately following the first detection within any one execution of the monitor routine 157 of a caution-categorized anomaly. In this manner, the announce caution condition subroutine 210 is like the announce alarm condition subroutine 186 particularly adapted to draw attention to the escalation of a hazardous condition without otherwise becoming a distraction from attending to previously detected hazardous conditions.

In any case, referring to FIG. 9A and recalling the discussion of the execution of the test routine 147 of FIG. 6, an exemplary announce alarm condition subroutine 186 is shown to begin with the selection by the microcontroller 56 of a tone message to be played by the implemented integrated message playback circuit 63 (step 187). With the address location for the desired tone message thus being established on the message address select inputs 74 of the integrated message playback circuit 63, execution of the announce alarm condition subroutine 186 continues to enable message playback (step 188) in the integrated message playback circuit 63. The appropriate logic level thus being established on the chip enable input 76 of the integrated message playback circuit 63, the integrated message playback circuit 63 operates for playback of the desired tone message as identified by the address location established on the message address select inputs 74.

At this point in the execution of the announce alarm condition subroutine 186, with the aural tone message being generated and output as described above, Applicant finds it appropriate to evaluate the state of the reset switch 111 (step 189). If the evaluation (step 189) of the reset switch 111 returns true, the announce alarm condition subroutine 186 branches to disable message playback (step 190) in the integrated message playback circuit 63, whereafter the announce alarm condition subroutine 186 terminates and the program flow returns to the beginning of the main program 140 (step 191) for reinitializing of the aural warning processor 20 and continued operation. If, on the other hand, the evaluation (step 189) of the reset switch 111 returns false, the announce alarm condition subroutine 186 branches to evaluate the state of the end-of-message flag signal (step 192) as output from the end-of-message flag output 78 of the integrated message playback circuit 63. If the evaluation (step 192) of the state of the end-of-message flag signal returns false, indicating that the integrated message playback circuit 63 has not yet completed generation and playback of the previously selected aural message, the announce alarm condition subroutine 186 loops back to the evaluation (step 189) of the reset switch 111 in order to allow the message playback to continue. If, on the other hand, the evaluation (step 192) of the state of the end-of-message flag signal returns true, indicating that the integrated message playback circuit 63 has fully completed generation and playback of the previously selected aural message, the announce alarm condition subroutine 186 continues to disable message playback (step 193) in the integrated message playback circuit 63, whereafter the announce alarm condition subroutine 186 ends and the sound alarm routine 179 continues with the execution of the playback all alarm messages subroutine 194 (step 181).

Referring then to FIG. 9B, execution of the playback all alarm messages subroutine 194 is shown to begin with selection by the microcontroller 56 for playback by the integrated message playback circuit 63 of the aural message corresponding to the current alarm number variable A, N_{A} (step 195). As will be appreciated by those of ordinary skill in the art, the then current alarm number variable A, N_{A} will be that variable for which an alarm-categorized signal from the host system failure detection circuits 91 has been assessed as indicating the existence of an anomalous condition. In any case, it should be recalled that, as has been previously discussed, the preferred implementation of the present invention will utilize a lookup table implemented within the integrated program memory space of the microcontroller 56 to determine the appropriate address within the integrated message playback circuit 63 of the warning message to be selected by the microcontroller 56. In any case, with the address location for the desired warning message thus being established on the message address select inputs 74 of the integrated message playback circuit 63, execution of the playback all alarm messages subroutine 194 continues to enable message playback (step 196) in the integrated message playback circuit 63. The appropriate logic level thus being established on the chip enable input 76 of the integrated message playback circuit 63, the integrated message playback circuit 63 operates for playback of the desired warning message as identified by the address location established on the message address select inputs 74.

At this point in the execution of the playback all alarm messages subroutine 194, with the aural tone message being generated and output as described above, Applicant finds it once again appropriate to evaluate the state of the reset switch 111 (step 197). If the evaluation (step 197) of the reset switch 111 returns true, the playback all alarm messages subroutine 194 branches to disable message playback (step 198) in the integrated message playback circuit 63, whereafter the playback all alarm messages subroutine 194 terminates and the program flow returns to the beginning of the main program 140 (step 199) for reinitializing of the aural warning processor 20 and continued operation. If, on the other hand, the evaluation (step 197) of the reset switch 111 returns false, the playback all alarm messages subroutine 194 branches to evaluate the state of the end-of-message flag signal (step 200) as output from the end-of-message flag output 78 of the integrated message playback circuit 63. If the evaluation (step 200) of the state of the end-of-message flag signal returns false, indicating that the integrated message playback circuit 63 has not yet completed generation and playback of the previously selected aural message, the playback all alarm messages subroutine 194 loops back to the evaluation (step 197) of the reset switch 111 in order to allow the message playback to continue. If, on the other hand, the evaluation (step 200) of the state of the end-of-message flag signal returns true, indicating that the integrated message playback circuit 63 has fully completed generation and playback of the previously selected aural message, the playback all alarm messages subroutine 194 continues to disable message playback (step 201) in the integrated message playback circuit 63 and the current alarm number variable N_{A} is decremented by one (step 202).

At this point, the playback all alarm messages subroutine 194 evaluates the newly decremented alarm number variable N_{A} (step 203) to determine whether every alarm-categorized signal from the host system failure detection circuits 91 has been assessed for the presence of an anomalous condition. If the evaluation (step 203) of the then current alarm number variable N_{A} returns true, indicating that every alarm-categorized signal from the host system failure detection circuits 91 has been assessed for the presence of an anomalous condition, the playback all alarm messages subroutine 194 branches to re-execute the previously described monitor routine 157 (step 204). If, on the other hand, the evaluation (step 203) of the then current alarm number variable N_{A} returns false, indicating that one or more alarm-categorized signals from the host system failure detection circuits 91 remain to be assessed for the presence of an anomalous condition, the playback all alarm messages subroutine 194 calls the get warning status function 174 for the newly decremented current alarm number variable pair A, N_{A} (step 205) and then proceeds to evaluate the warning status for the then current alarm number variable pair A, N_{A} (step 206).

If the evaluation (step 206) of the current alarm number variable pair A, N_{A} returns true, indicating that an additional alarm-categorized anomalous condition was detected through the previously called get warning status function 174, the playback all alarm messages subroutine 194 loops back to its beginning for selection (step 195) and playback (step 196) of the aural message corresponding to the newly detected anomaly and further processing as previously described. If, on the other hand, the evaluation (step 206) of the current alarm number variable pair A, N_{A} returns false, indicating that no alarm-categorized anomalous condition was detected through the previously called get warning status function 174, the playback all alarm messages subroutine 194 branches to further decrement the current alarm number variable N_{A} (step 207) and then again evaluate the newly decremented alarm number variable N_{A} (step 208) to determine whether every alarm-categorized signal from the host system failure detection circuits 91 has been assessed for the presence of an anomalous condition. If the evaluation (step 208) of the then current alarm number variable N_{A} returns false, indicating that one or more alarm-categorized signals from the host system failure detection circuits 91 still remain to be assessed for the presence of an anomalous condition, the playback all alarm messages subroutine 194 loops back to call once again the get warning status function 174 (step 205) and for further assessment thereafter. If, one the other hand, the evaluation (step 208) of the then current alarm number variable N_{A} returns true, indicating that every alarm-categorized signal from the host system failure detection circuits 91 has finally been assessed for the presence of an anomalous condition, the playback all alarm messages subroutine 194 branches to re-execute the previously described monitor routine 157 (step 209).

Referring to FIG. 10A, an exemplary announce caution condition subroutine 210 is shown to begin with the selection by the microcontroller 56 of a tone message, which, as previously mentioned, preferably differs from the tone message associated with the announce alarm condition subroutine 186 of FIG. 9A, to be played by the implemented integrated message playback circuit 63 (step 211). With the address location for the desired tone message thus being established on the message address select inputs 74 of the integrated message playback circuit 63, execution of the announce caution condition subroutine 210 continues to enable message playback (step 212) in the integrated message playback. circuit 63. The appropriate logic level thus being established on the chip enable input 76 of the integrated message playback circuit 63, the integrated message playback circuit 63 operates for playback of the desired tone message as identified by the address location established on the message address select inputs 74.

At this point in the execution of the announce caution condition subroutine 210, with the aural tone message being generated and output as described above, Applicant finds it appropriate to evaluate the state of the reset switch 111 (step 213). If the evaluation (step 189) of the reset switch 111 returns true, the announce caution condition subroutine 210 branches to disable message playback (step 214) in the integrated message playback circuit 63, whereafter the announce caution condition subroutine 210 terminates and the program flow returns to the beginning of the main program 140 (step 215) for reinitializing of the aural warning processor 20 and continued operation. If, on the other hand, the evaluation (step 213) of the reset switch 111 returns false, the announce caution condition subroutine 210 branches to evaluate whether an alarm-categorized anomaly has newly arisen, to which end an evaluation loop for the alarm-categorized anomalies is established.

As shown in FIG. 10A, the evaluation loop established under the announce caution condition subroutine 210 begins by resetting the alarm number variable N_{A} to the maximum number A_{MAX} of alarm categorized anomalies for which the aural warning processor 20 is programmed to monitor (step 216). The evaluation loop for the alarm-categorized anomalies thus initialized, the announce caution condition subroutine 210 continues to call the get warning status function 174 for the current alarm number variable pair A, N_{A} (step 217). Upon return of the get warning status function 174 as called (step 217) for the current alarm number variable pair A, N_{A}, the announce caution condition subroutine 210 then proceeds to evaluate the warning status for the then current alarm number variable pair A, N_{A} (step 218). If the evaluation (step 218) of the current alarm number variable pair A, N_{A} returns true, indicating that an alarm-categorized anomalous condition was detected through the previously called get warning status function 174, the announce caution condition subroutine 210 terminates for execution of the sound alarm routine 179 (step 219), as previously described in detail. If, on the other hand, the evaluation (step 218) of the current alarm number variable pair A, N_{A} returns false, indicating that no alarm-categorized anomalous condition was detected through the previously called get warning status function 174, the announce caution condition subroutine 210 branches to decrement the current alarm number variable N_{A} by one (step 220) and then evaluates the newly decremented alarm number variable N_{A} (step 221) to determine whether every alarm-categorized signal from the host system failure detection circuits 91 has been assessed for the presence of an anomalous condition.

If the evaluation (step 221) of the then current alarm number variable N_{A} returns false, indicating that one or more alarm-categorized signals from the host system failure detection circuits 91 remain to be assessed for the presence of an anomalous condition, the announce caution condition subroutine 210 loops back for further assessment. Unless there is determined an alarm-categorized anomaly, however, the value of the alarm number variable N_{A} will continue to be decremented (step 220) until eventually the evaluation (step 221) of the then current alarm number variable N_{A} returns true, indicating that every alarm-categorized signal from the host system failure detection circuits 91 has been assessed for the presence of an anomalous condition. Once the evaluation (step 221) of the then current alarm number variable N_{A} returns true, the announce caution condition subroutine 210 will then continue to evaluate the state of the end-of-message flag signal (step 222) as output from the end-of-message flag output 78 of the integrated message playback circuit 63.

If the evaluation (step 222) of the state of the end-of-message flag signal returns false, indicating that the integrated message playback circuit 63 has not yet completed generation and playback of the previously selected aural message, the announce caution condition subroutine 210 loops back to the evaluation (step 213) of the reset switch 111 in order to allow the message playback to continue. If, on the other hand, the evaluation (step 222) of the state of the end-of-message flag signal returns true, indicating that the integrated message playback circuit 63 has fully completed generation and playback of the previously selected aural message, the announce caution condition subroutine 210 continues to disable message playback (step 223) in the integrated message playback circuit 63, whereafter the announce caution condition subroutine 210 ends and the sound caution routine 182 continues with the execution of the playback caution message subroutine 224 (step 184).

Referring then to FIG. 10B, execution of the playback caution message subroutine 224 is shown to begin with selection by the microcontroller 56 for playback by the integrated message playback circuit 63 of the aural message corresponding to the current caution number variable pair C, N_{C} (step 225), as determined by reference to the lookup table as previously described. In any case, with the address location for the desired warning message thus being established on the message address select inputs 74 of the integrated message playback circuit 63, execution of the playback caution message subroutine 224 continues to enable message playback (step 226) in the integrated message playback circuit 63. The appropriate logic level thus being established on the chip enable input 76 of the integrated message playback circuit 63, the integrated message playback circuit 63 operates for playback of the desired warning message as identified by the address location established on the message address select inputs 74.

At this point in the execution of the playback caution message subroutine 224, with the aural tone message being generated and output as described above, Applicant finds it once again appropriate to evaluate the state of the reset switch 111 (step 227). If the evaluation (step 227) of the reset switch 111 returns true, the playback caution message subroutine 224 branches to disable message playback (step 228) in the integrated message playback circuit 63, whereafter the playback caution message subroutine 224 terminates and the program flow returns to the beginning of the main program 140 (step 229) for reinitializing of the aural warning processor 20 and continued operation. If, on the other hand, the evaluation (step 227) of the reset switch 111 returns false, the playback caution message subroutine 224 branches to evaluate whether an alarm-categorized anomaly has newly arisen, to which end an evaluation loop for the alarm- categorized anomalies is established.

As shown in FIG. 10B, the evaluation loop established under the playback caution message subroutine 224 begins by resetting the alarm number variable N_{A} to the maximum number A_{MAX} of alarm categorized anomalies for which the aural warning processor 20 is programmed to monitor (step 230). The evaluation loop for the alarm-categorized anomalies thus initialized, the playback caution message subroutine 224 continues to call the get warning status function 174 for the current alarm number variable pair A, N_{A} (step 231). Upon return of the get warning status function 174 as called (step 231) for the current alarm number variable pair A, N_{A}, the playback caution message subroutine 224 then proceeds to evaluate the warning status for the then current alarm number variable pair A, N_{A} (step 232). If the evaluation (step 232) of the current alarm number variable pair A, N_{A} returns true, indicating that an alarm-categorized anomalous condition was detected through the previously called get warning status function 174, the playback caution message subroutine 224 terminates for execution of the sound alarm routine 179 (step 233), as previously described in detail. If, on the other hand, the evaluation (step 232) of the current alarm number variable pair A, N_{A} returns false, indicating that no alarm-categorized anomalous condition was detected through the previously called get warning status function 174, the playback caution message subroutine 224 branches to decrement the current alarm number variable N_{A} by one (step 234) and then evaluates the newly decremented alarm number variable N_{A} (step 235) to determine whether every alarm-categorized signal from the host system failure detection circuits 91 has been assessed for the presence of an anomalous condition.

If the evaluation (step 235) of the then current alarm number variable N_{A} returns false, indicating that one or more alarm-categorized signals from the host system failure detection circuits 91 remain to be assessed for the presence of an anomalous condition, the playback caution message subroutine 224 loops back for further assessment. Unless there is determined an alarm-categorized anomaly, however, the value of the alarm number variable N_{A} will continue to be decremented (step 234) until eventually the evaluation (step 235) of the then current alarm number variable N_{A} returns true, indicating that every alarm-categorized signal from the host system failure detection circuits 91 has been assessed for the presence of an anomalous condition. Once the evaluation (step 235) of the then current alarm number variable N_{A} returns true, the playback caution message subroutine 224 will then continue to evaluate the state of the end-of-message flag signal (step 236) as output from the end-of-message flag output 78 of the integrated message playback circuit 63.

If the evaluation (step 236) of the state of the end-of-message flag signal returns false, indicating that the integrated message playback circuit 63 has not yet completed generation and playback of the previously selected aural message, the playback caution message subroutine 224 loops back to the evaluation (step 227) of the reset switch 111 in order to allow the message playback to continue. If, on the other hand, the evaluation (step 236) of the state of the end-of-message flag signal returns true, indicating that the integrated message playback circuit 63 has fully completed generation and playback of the previously selected aural message, the playback caution message subroutine 224 continues to disable message playback (step 227) in the integrated message playback circuit 63, whereafter the playback caution message subroutine 224 ends and the sound caution routine 182 continues with the execution of the additional caution determination subroutine 238 (step 185).

Referring now to FIG. 10C, the additional caution determination subroutine 238 is shown to begin by decrementing the current caution number variable N_{C} by one (step 239). At this point, the additional caution determination subroutine 238 evaluates the newly decremented caution number variable N_{C} (step 240) to determine whether every caution-categorized signal from the host system failure detection circuits 91 has been assessed for the presence of an anomalous condition. If the evaluation (step 240) of the then current caution number variable N_{C} returns true, indicating that every caution-categorized signal from the host system failure detection circuits 91 has been assessed for the presence of an anomalous condition, the additional caution determination subroutine 238 terminates to re-execute the previously described monitor routine 157 (step 241). If, on the other hand, the evaluation (step 240) of the then current caution number variable N_{C} returns false, indicating that one or more caution-categorized signals from the host system failure detection circuits 91 remain to be assessed for the presence of an anomalous condition, the additional caution determination subroutine 238 branches to to evaluate the state of the reset switch 111 (step 242). If the evaluation (step 242) of the reset switch 111 returns true, the additional caution determination subroutine 238 terminates and the program flow returns to the beginning of the main program 140 (step 243) for reinitializing of the aural warning processor 20 and continued operation. If, on the other hand, the evaluation (step 242) of the reset switch 111 returns false, the additional caution determination subroutine 238 branches to evaluate whether an alarm-categorized anomaly has newly arisen, to which end an evaluation loop for the alarm-categorized anomalies is established.

As shown in FIG. 10C, the evaluation loop established under the additional caution determination subroutine 238 begins by resetting the alarm number variable N_{A} to the maximum number A_{MAX} of alarm categorized anomalies for which the aural warning processor 20 is programmed to monitor (step 244). The evaluation loop for the alarm-categorized anomalies thus initialized, the additional caution determination subroutine 238 continues to call the get warning status function 174 for the current alarm number variable pair A, N_{A} (step 245). Upon return of the get warning status function 174 as called (step 245) for the current alarm number variable pair A, N_{A}, the additional caution determination subroutine 238 then proceeds to evaluate the warning status for the then current alarm number variable pair A, N_{A} (step 246). If the evaluation (step 246) of the current alarm number variable pair A, N_{A} returns true, indicating that an alarm-categorized anomalous condition was detected through the previously called get warning status function 174, the additional caution determination subroutine 238 terminates for execution of the sound alarm routine 179 (step 247), as previously described in detail. If, on the other hand, the evaluation (step 246) of the current alarm number variable pair A, N_{A} returns false, indicating that no alarm-categorized anomalous condition was detected through the previously called get warning status function 174, the additional caution determination subroutine 238 branches to decrement the current alarm number variable N_{A} by one (step 248) and then evaluates the newly decremented alarm number variable N_{A} (step 249) to determine whether every alarm-categorized signal from the host system failure detection circuits 91 has been assessed for the presence of an anomalous condition.

If the evaluation (step 249) of the then current alarm number variable N_{A} returns false, indicating that one or more alarm-categorized signals from the host system failure detection circuits 91 remain to be assessed for the presence of an anomalous condition, the additional caution determination subroutine 238 loops back for further assessment. Unless there is determined an alarm-categorized anomaly, however, the value of the alarm number variable N_{A} will continue to be decremented (step 248) until eventually the evaluation (step 249) of the then current alarm number variable N_{A} returns true, indicating that every alarm-categorized signal from the host system failure detection circuits 91 has been assessed for the presence of an anomalous condition. Once the evaluation (step 249) of the then current alarm number variable N_{A} returns true, the additional caution determination subroutine 238 will continue to call the get warning status function 174 for the then current caution number variable pair C, N_{C} (step 250) and, thereafter, evaluate the warning status for the then current caution number variable pair C, N_{C} (step 251). If the evaluation (step 251) of the current caution number variable pair C, N_{C} returns false, indicating that no caution-categorized anomalous condition was detected through the previously called get warning status function 174, the additional caution determination subroutine 238 repeats from its beginning with the further decrementing of the current caution number variable N_{C} (step 239). If, on the other hand, the evaluation (step 251) of the current caution number variable pair C, N_{C} returns true, indicating that a caution-categorized anomalous condition was detected through the previously called get warning status function 174, the additional caution determination subroutine 238 terminates for re-execution of the playback caution message subroutine 224 (step 252) with the then current caution number variable pair C, N_{C}.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, it is noted that in the foregoing descriptions of the execution of the implemented sound alarm routine 179 and the execution of the implemented sound caution routine 182 no evaluation was ever made of the state of the test switch 112. While this omission is purposeful to the extent that it is Applicant's position that in the most preferred embodiment of the present invention that a “test” input for the system (at least as described herein) should not be allowed during the aural reporting of an anomalous condition. To the extent that a particular implementation should however make such allowance, the same should nonetheless be considered as within the scope of the present invention.

Additionally, it is noted that while Applicant has set forth an example of an aural message that might be used in connection with a “test” event, it is noted that an exhaustive list has not been set forth. To be sure, one of the advantages of the present invention is the ability to readily implement any of a wide variety of specific aural messages, including the version of the aural warning processor 20 for multiple language support. This said, and simply by way of example, those of ordinary skill in the art will recognize that appropriate aural messages for some of the previously discussed possible anomalies with respect to a helicopter 89 might include the following: corresponding to the engine transmission oil pressure warning light 106, the aural message “WARNING . . . TRANSMISSION OIL PRESSURE FAULT;” corresponding to the combining transmission oil temperature warning light 107, the aural message “WARNING . . . C-BOX OIL TEMPERATURE FAULT;” corresponding to a low fuel indicator light 109 for a particular engine, the aural message “CAUTION . . . FUEL LOW ENGINE ONE;” and corresponding to a chip detection indicator light 110, the aural message “CAUTION . . . ENGINE ONE CHIP” for a engine one or the aural message “CAUTION . . . C-BOX CHIP” for the combining transmission. As will be appreciated by those ordinary skill in the art, the ability to include with each message an optional aural prefix enables the aural warning processor 20 of the present invention to be adapted for focusing the attention of the crewmembers 123, 124 to the general nature of the warning prior to conveying the precise warning.

Still further, while the aural warning processor 20 of the present invention has been described as providing great advantage in situations of task overload for crewmembers 123, 124 and failure of other subsystems such as, for example, an otherwise provided host system visual warning device 102, it should be appreciated that in many host systems 88 environmental issues can arise such that the utility of the aural warning processor 20 is heightened. For example, it is commonplace for a helicopter 89, or other similar host system 88, to be provided with a very large, generally transparent windscreen 125, side windows and even overhead window panels as are necessary to maximize exterior visibility for the crewmembers 123, 124. Unfortunately, however, even with the provision of an instrument panel shroud 129, the provided windows results in much light entering the cockpit 122, which in some cases may make it very difficult for the crewmembers 123, 124 to notice an active indicator light 104 on the annunciator panel 103. In any case, however, because the scope of the present invention is much broader than any particular embodiment, the foregoing detailed description should not be construed as a limitation of the scope of the present invention, which is limited only by the claims appended hereto.

What is claimed is:

1. A processor for producing aural messages responsive to external signal inputs, said processor comprising:
a monitoring circuit, said monitoring circuit being adapted to selectively collect electrical signals generated external to said processor;
a signal generator, said signal generator being adapted to selectively produce an electrical representation of any one of a plurality of electronically stored aural signals;
a controller, said controller being adapted to:
control selection by said monitoring circuit of any one of the electrical signals generated external to said processor;
perform an analysis of said selected electrical signal generated external to said processor, said analysis being determinative of an indication within said selected electrical signal of an anomalous condition; and
control selection by said signal generator of any one of the electronically stored aural signals, said selection of said one of the electronically stored aural signals being made according to said analysis of said selected electrical signal generated external to said processor; and
an aural output device in electrical communication with said signal generator, said aural output device being adapted to convert said electrical representation of any one of a plurality of electronically stored aural signals to the represented aural signal.

2. The processor for producing aural messages responsive to external signal inputs as recited in claim 1, wherein said controller comprises a microcontroller.

3. The processor for producing aural messages responsive to external signal inputs as recited in claim 1, wherein:
said signal generator comprises an integrated memory; and
said electronically stored aural signals are electronically stored in said integrated memory of said signal generator.

4. The processor for producing aural messages responsive to external signal inputs as recited in claim 1, wherein said processor is adapted for integration with a host system.

5. The processor for producing aural messages responsive to external signal inputs as recited in claim 4, wherein said signals generated external to said processor are produced a failure detection system associated with said host system.

6. The processor for producing aural messages responsive to external signal inputs as recited in claim 5, wherein said failure detection system comprises a plurality of transducers, each said transducer being adapted to convert a measurement of the physical state of a subsystem of said host system to an electrical signal.

7. The processor for producing aural messages responsive to external signal inputs as recited in claim 4, said processor further comprising an interface for integration of said processer with said host system.

8. The processor for producing aural messages responsive to external signal inputs as recited in claim 7, wherein said interface comprises an electrical connector.

9. The processor for producing aural messages responsive to external signal inputs as recited in claim 8, wherein said interface comprises a plurality of electrical connectors.

10. The processor for producing aural messages responsive to external signal inputs as recited in claim 8, wherein said connector is adapted to provide electrical connectivity between said processor and a visual warning device provided in connection with said host system, said visual warning device being adapted to display a visual indication of the existence of an anomalous condition respecting a subsystem of said host system as measured by said failure detection system.

11. The processor for producing aural messages responsive to external signal inputs as recited in claim 10, wherein said aural output device is provided external to said processor in connection with said host system.

12. The processor for producing aural messages responsive to external signal inputs as recited in claim 7, wherein said aural output device is provided external to said processor in connection with said host system.

13. The processor for producing aural messages responsive to external signal inputs as recited in claim 12, wherein said aural output device comprises an audio loudspeaker.

14. The processor for producing aural messages responsive to external signal inputs as recited in claim 12, wherein said aural output device comprises a connection adapted for interface with an audio headset.

15. The processor for producing aural messages responsive to external signal inputs as recited in claim 12, wherein said aural output device comprises an audio controller.

16. The processor for producing aural messages responsive to external signal inputs as recited in claim 12, wherein said electrical representation produced by said signal generator of said electronically stored aural signals comprises a digital signal.

17. The processor for producing aural messages responsive to external signal inputs as recited in claim 12, wherein said electrical representation produced by said signal generator of said electronically stored aural signals comprises an analog signal.
